(19) United States
(12) Patent Application Publication
(10) Pub. No.: US 2003/0194578 A1
(43) Pub. Date: Oct. 16, 2003

(54) Security articles comprising multi-responsive physical colorants

(75) Inventors: Thomas Y. Tam, Richmond, VA (US); Samir Z. Abdalla, Midlothian, VA (US); Kwok-Wai Lem, Randolph, NJ (US); Juergen Wieczoreck, Garbsen (DE)

Correspondence Address: Honeywell International, Inc., Colleen D. Szuch, Esq., 101 Columbia Road, Morristown, NJ, 07962-1057, US

(73) Assignee: Honeywell International, Inc., Morristown, NJ

(21) Appl. No.: 10/308,055

(22) Filed: Dec. 2, 2002

Related U.S. Application Data
(60) Provisional application No. 60/342,803, filed on Dec. 20, 2001.

(51) Int. Cl. B32B 5/16

(52) U.S. Cl. 428/690; 428/323

(57) ABSTRACT

Security articles comprising elements such as filaments, fibers, including hollow fibers, and threads and thin transverse sections and chopped versions thereof, wherein such elements are dispersed within the articles. Particle scattering and luminescent technology is employed based on scattering, electronic, magnetic and/or light properties to provide compound physical coloration responsive to various portions of the electromagnetic spectrum, including ultraviolet, ambient and infrared. The coloration effects can be highly stable or dependent on specific switching effects linked to, e.g., thermal exposure or actinic radiation. The security articles result in advanced levels of security to avoid counterfeiting of objects including banknote and currency paper, stock and bond certificates, identification, credit, debit and ATM cards, drivers' licenses and bar codes.

### CROSS-REFERENCE TO RELATED APPLICATIONS

The present application claims the benefit of U.S. Provisional Patent Application No. 60/342,803 filed Dec. 20, 2001, the entire disclosure of which is incorporated herein by reference.

### BACKGROUND OF THE INVENTION

Various methods have been described for imparting coloration, including luminescence, to polymeric compositions and articles, such as fibers, filaments, film, molded objects, etc. To achieve coloration, an additive such as a dye, pigment or luminescent agent such as a doped zinc sulfide, a metal aluminate oxide, a rare earth oxysulfide, a Group 3 inorganic oxide including dopants of, e.g., the Lanthanide series of the Periodic Table of the Elements, has been incorporated into a composition in order to achieve the desired result, see U.S. Pat. No. 5,674,437 and U.S. Ser. No. 09/790041, filed Feb. 21, 2001. In another approach, coloration has been achieved using particle scattering technology, see U.S. Pat. No. 5,932,309; U.S. Pat. No. 6,074,742; U.S. Pat. No.6,150,019; and U.S. Pat. No. 6,153,299. Each of the identified patents and the patent application is incorporated herein to the extent permitted. For purposes of the present invention, luminescence includes both fluorescence and phosphorescence.

Security fibers are fibers incorporated in documents or other articles for the purpose of ensuring identification, authentication, and protection against forgery, imitation or falsification. The term “security thread” has been employed to describe twisted or braided fibers or strips of film for the same purposes.

German Patent 19802588 describes cellulose fibers containing luminescent additives for security purposes.

European Patent 066854 B1 describes cellulose acetate security fibers and security papers containing the fibers. The security fibers are spun from an acetone solution containing a lanthanide chelate. The fibers are colorless under normal lighting but show narrow-band emission in the visible or infrared (IR) when excited by ultraviolet (UV) light. A security thread twined of fibers having different luminophors is described wherein coded information is impressed on the security thread.

U.S. Pat. Nos. 4,655,788 and 4,921,280 describe security fibers invisible in sunlight or artificial light, which under excitation by IR, UV or x-rays, exhibit a luminescence. The security fibers are prepared by a process of dyeing conventional textile fibers such as polyester, polyamide and cellulosic fibers with rare earth chelates.

German Patent DE-A 14 46 851 describes a security thread having a microprint executed in several colors.

U.S. Pat. No. 4,897,300 describes a security thread having luminescent colors that are invisible in normal lighting and are provided along the security thread in successive and overlapping portions which, when the colors are excited, have a length recognizable to the naked eye and in the overlapping areas have characteristic mixed luminescences. The security threads are produced by printing strip shapes on flat sheets and then cutting them up.

U.S. Pat. No. 6,068,895 describes a woven security label incorporating a detectable filament made by adding about 20 weight percent (wt. %) of an inorganic fluorescent substance to polyester dope and spinning filaments out of the dope.

U.S. Pat. No. 4,183,989 describes a security paper having at least two machine verifiable security features, one of which is a magnetic material, and a second of which may be a luminescent material. The luminescent material is dispersed in a lacquer and coated onto a film. The film is divided into planchettes of approximately 1 mm diameter and incorporated in the paper.

Korean Patent KR 9611906 and WO 9945200 describe methods of preparing luminescent fibers by dyeing. Korean Patent KR 9611906 describes the incorporation of the fibers into paper material.

Chinese Patent No. CN 1092119 describes polyvinyl alcohol fibers of 1-10 mm length containing pigments, dyes and fluorescent materials.

U.S. Pat. Nos. 5,876,068, 5,990,197, and 6,099,930 describe yet other means of providing security elements involving luminescent substances.

In a related area, British Patent GB 1,569,283 describes an apparatus for verifying the authenticity of documents coded with fluorescent substances.

Luminescent substances have also been incorporated into fibers for general purposes unrelated to security applications as well as for unspecified purposes.

U.S. Pat. No. 4,781,647 describes a method of producing phosphorescent filaments by mixing phosphors, preferably zinc, cadmium or calcium sulfide into the polymer together with a coupling agent prior to extrusion and spinning into fibers for dolls' hair.

U.S. Pat. No. 5,321,069 describes a process for producing phosphorescent bulked continuous filament (BCF) yarns of thermoplastic polymers for textile applications by melt spinning. The process comprises the steps of mixing the polymer pellets with a wetting agent, preferably mineral oil, adding a phosphorescent powder such as zinc sulfide to substantially uniformly coat the pellets, and heating in an extruder to form and extrude a melt whereby a uniform distribution of phosphorescent pigment is said to be obtained throughout the filaments. The individual filaments may be solid or hollow and may have any conventional shape

U.S. Pat. No. 5,674,437 describes a method for preparing luminescent fibers comprising the steps of combining in an extruder a thermoplastic polymer with a luminescent metal aluminate pigment, heating and mixing to melt the polymer, and extruding the melt to form a fiber.

U.S. Pat. No. 3,668,189 describes fiber forming fluorescent polycarbonamides prepared by co-polymerization of a fused ring polynuclear aromatic hydrocarbon moiety having at least three fused rings.

Japanese Pat. Nos. 7300722 A2 and 2000096349 A2 describe sheath-core fibers with the core containing the luminescent substance.

U.S. patent application Ser. No. 09/790041, filed Feb. 21, 2001, commonly assigned to the assignee of the present invention, discloses security articles comprising fibers, threads and fiber sections possessing specific, multiple verification characteristics. In particular, security is achieved based on fibers that have complex cross-sections, components and multiple luminescent responses. The disclosure of this application is incorporated herein by reference to the extent permitted.

A significant advance in the production of color in articles, including fibers, threads and film, is disclosed in commonly assigned U.S. Pat. No. 5,932,309, incorporated herein by reference to the extent permitted. To achieve coloration, the invention utilizes particle scattering effects and/or electronic transition colorants, as defined in the patent. The resulting coloration in an article can be highly stable or responsive to switching effects of, e.g., temperature, thermal exposure, moisture absorption and exposure to actinic radiation. For purposes of the present invention and convenience, this technology is generally referred to “particle scattering”.

While each of these methods has advantages for providing desirable coloration effects, a continuing need exists for further coloration effects that are particularly useful in security applications in order to thwart counterfeiting that may be directed to the properties or characteristics of a single type of pigment or method of achieving coloration, as well as to be able to tailor specific identity characteristics for specific users.

### SUMMARY OF THE INVENTION

A security article comprising a matrix component in which: (A) at least one particle scattering colorant is dispersed; and (B) at least one luminescent substance is dispersed; wherein: (1) said at least one particle scattering colorant comprises particles selected from the group consisting of a semiconductor, metallic conductor, metal oxide, metal salt or mixture thereof; (2) said at least one particle scattering colorant has an average cross-sectional size in the smallest dimension of less than about 0.2 micron; (3) said polymer matrix component is substantially non-absorbing in the visible region of the spectrum; (4) said particle scattering colorant has a minimum in the transmitted light intensity ratio in the 380 to 750 nanometer range that is shifted at least by 10 nanometers compared with that obtained for the same semiconductor, metallic conductor, metal oxide, metal salt or mixture thereof having an average particle size above about 20 microns; and (5) said luminescent substance is selected from the group consisting of at least one fluorescent substance, at least one phosphorescent substance, mixtures of at least one fluorescent and at least one phosphorescent substance, wherein said luminescent substance exhibits a luminescent spectral response peak when excited by at least one wavelength selected from the electromagnetic spectral region of from about 200 to about 2,000 nanometers.

In another embodiment, there is provided A security article comprising at least one first composition and at least one second composition: (A) said first composition comprising a solid first matrix component, a particle scattering colorant and at least one luminescent substance dispersed therein; (B) said at least one second composition comprising a polymer second matrix component, and a colorant selected from the group consisting of an electronic transition colorant, dye and pigment dispersed therein; (C) said at least one first composition being either; (1) disposed on and substantially exterior to said second composition on at least one side of the article; or (2) said first and second compositions are substantially mutually interpenetrating; wherein: (i) there exists at least one incident visible light wavelength and one incident light angle such that said first composition absorbs less than about 90% of the light incident on said article; (ii) the absorption coefficient of said at least one first composition is less than about 50% of that of said second composition at a wavelength in the visible region of the spectrum; (iii) the highest absorption peak of said particle scattering colorant does not fall in the visible region of the spectrum; (iv) said luminescent substance is selected from the group consisting of at least one fluorescent substance, at least one phosphorescent substance, and a mixture of at least one fluorescent and at least one phosphorescent substance, wherein said luminescent substance exhibits a luminescent spectral response peak when excited by one or more wavelength selected from the electromagnetic spectral region of about 200 to about 2,000 nanometers; and (v) either: (a) said particle scattering colorant has a refractive index that matches that of said first matrix component at a wavelength in the visible and has an average particle size of less than about 2000 microns; or (b) the average refractive index of said particle scattering colorant differs from that of said first matrix component by at least about 5% in the visible wavelength range, the average particle size of said particle scattering colorant in the smallest dimension is less than about 2 microns, and said particle scattering colorant, when dispersed in a colorless, isotropic liquid having a substantially different refractive index, is characterized at visible wavelengths as having an effective maximum absorbance that is at least about 2 times the effective minimum absorbance.

Security articles comprise filaments, fibers, thin transverse sections of filaments and fibers also referred to as dots, threads, chopped filaments and fibers or threads also referred to as fibrils, film, slit film and various objects that incorporate filaments, fibers, threads, dots, fibrils, film and slit film. Such objects can include paper, banknotes, identification cards, credit and debit cards, automatic teller machine access cards, paper on which licenses, diplomas and other documents requiring avoidance of counterfeiting are printed, bar codes, etc.

### DETAILED DISCLOSURE

The present invention relates to security articles comprising fibers, threads, thin transverse fiber sections (also referred to as “dots”) and chopped fiber (for convenience also referred to herein as “fibrils”), as well as film and slit film, such security articles possessing multiple verification characteristics. Additionally, such articles can be in the form of a sheet-like or planar structure having greater thickness than a film, e.g., measured in tenths of an inch or inches rather than thousandths of an inch; such as cards and boards. The fibers possess unique and difficult-to-duplicate combinations of components, compositions and multiple luminescent responses. The verifiable characteristics of the security fibers, threads, fibrils and dots provide high levels of protection against fraudulent duplication of articles in which they are incorporated and provide alternative means for tailoring specific identity characteristics for specific applications and multiple users.

For purposes of the present invention, a luminescent response includes a phosphorescent response, a fluorescent response and a combination of a phosphorescent and fluorescent responses to excitation light energy in the ultraviolet, visible (e.g., white light) and infrared (IR) regions of the electromagnetic spectrum. Such responses may be observable under various conditions: for example, ambient or daylight; under dim ambient light or in darkness; or under illumination of light from the ultraviolet or infrared region of the electromagnetic spectrum. Furthermore, the luminescent effect may be a fluorescent effect observable only during the time when the excitation source is present or within less than a second thereafter; it may be a phosphorescent effect observable for a short time after the activating light energy is terminated, e.g., up to about 1 to about 10 minutes after excitation; and it may be a phosphorescent effect observable long after termination of the activation energy, such effect referred to herein as “afterglow”. Such periods of afterglow can be from greater than about 10 minutes and up to about 200 minutes or longer; for example, from about 15 minutes to about 120 minutes; or from about 15 minutes to about 60 minutes. It is the permutations and combinations of these various luminescent responses, contributed by particle scattering effects, as well as phosphorescence and fluorescence, that result in the unique security articles of the present invention. The ability to observe these effects in the presence of one another is particularly valuable in the development of security articles that are resistant to counterfeiting.

The security articles of the present invention include security fibers that are single filaments (monofilaments) or assemblies of monofilaments. Where fiber cross-section is discussed below, it will be understood that reference is made to the monofilament cross-section unless otherwise stated. The fibers, threads and dots of the invention are inserted into papers, documents and other articles by appropriate processes known in the art to provide enhance levels of security.

Security fibers of the invention are preferably formed from synthetic polymers by continuous processes, such as melt spinning, wet spinning, dry spinning, gel spinning and others. Synthetic fibers typically are conventionally spun with round cross-sections as well as triangular, rectangular, trilobal, quadrilobal, and other shapes are known. Fiber cross-sections may also contain holes, for example, circular or oval in shape, that extend through the entire length of the fiber and can have a constant or variable cross-sectional dimension along those lengths. The greater the degree of complexity of a fiber cross-section, the greater the difficulty of the design of a spinneret to produce same, and the greater the degree of difficulty to duplicate this design by a fraudulent party. Hollow fibers and sheath/core fibers are particularly useful in combination with particle scattering effect technology.

Fibers of the present invention can vary in the number, location, composition and physical properties of components. Multicomponent fibers, for example, bicomponent fibers are known having two distinct cross-sectional domains of two distinct polymer types differing from each other in composition (e.g., polyester vs. nylon) and can further differ in composition or visual response, e.g., color. Bicomponent fibers and methods for their manufacture are described for example in U.S. Pat. Nos. 4,552,603, 4,601,949, and 6,158,204. The disclosures of these patents are hereby incorporated by reference to the extent permitted. The components may be in a side-by-side relationship or in a sheath-core relationship. In one embodiment, the number of components in the security fibers of the invention is at least two. In a preferred configuration, the components in a multi-component fiber are in a side-by-side relationship with one another such as described in U.S. Pat. No. 6,158,204. The portions of the cross-sections labeled A and B in FIGS. 2-6 thereof represent different components.

The components may be of different polymer compositions, including different polymers or polymer mixtures, sometimes referred to herein as a matrix. For purposes of the present invention, a matrix refers to a polymer or polymer composition in which the color effecting agent(s) is(are) dispersed. It is preferred that the components are comprised of the same polymer but include different pigments, luminescent agents and/or constructions using, e.g., particle scattering technology, that allow for different color responses under normal, or ambient, lighting conditions as well as different luminescent responses to UV or IR illumination. Polymers useful in the present invention include those selected from the group consisting of polyamides, polyesters, polyolefins, polyacrylics, polyalcohols, polyethers, polyketones, polycarbonates, polysulfides, polyurethanes, and cellulosic and polyvinyl derivatives. Polyolefins, polyesters and polyamides are preferred. Most preferred polymers are polypropylene, polyethylene terephthalate, polytrimethylene terephthalate, nylon 6 and nylon 66.

Fibers useful in the present invention have an effective diameter of about 0.01 mm to about 3 mm. For the purposes of this invention, “effective diameter” is the diameter of the smallest circle that can circumscribe the fiber cross-section. In one embodiment of the invention, the fibers are transversely sectioned into cross-sectional slices of from about 0.005 mm to about 0.5 mm thickness. The resulting slices, referred to herein as “dots”, can be incorporated into paper or other articles where the cross-sections, components and luminescent responses are readily identified with the naked eye or under moderate magnification and appropriate illumination.

Another security feature of the fibers of the invention is multiple luminescent responses of the pigments employed. In particular, luminescent responses as a consequence of incorporating such additives include phosphorescence, fluorescence and afterglow. The luminescent responses include wavelengths in the infrared, the visible and the ultra-violet regions of the spectrum. For purposes of the present invention the various regions of the electromagnetic spectrum are defined as follows: the infrared spectrum begins at wavelengths greater than about 700 nanometers (nm) and extends to about 2000 nm; the visible spectrum is in the wavelength region of from about 380 to about 750 nm; and the ultraviolet spectrum is in the region of from about 200 to about 400 nm. While the values recited overlap, one skilled in the art will understand that each of these regions has well understood characteristics. Luminescent substances are incorporated in one or more of the components of the security articles of the invention. A single luminescent substance may have multiple luminescent responses as indicated by multiple intensity peaks in its luminescent spectrum. For the purposes of this invention, spectral peaks having an intensity less than about one-fifth of the maximum peak intensity are disregarded.

In one embodiment, a security fiber has one component, which component contains one or more luminescent substances presenting different luminescent responses to illumination of the same or different wavelengths. In another embodiment, the security fibers are multi-component fibers, each containing a single luminescent substance but with different luminescent responses to the same or different wavelengths. In yet another embodiment, the security fibers are multi-component fibers, at least one of which contains multiple luminescent substances with different luminescent responses to illuminations of the same or different wavelengths.

Luminescence of the security articles of the invention is achieved by incorporation of luminescent materials, including copolymers, pigments or dyes prior to or during spinning, or by dyeing of the spun fiber with luminescent dyes, as well as by utilization of various physical and structural aspects of particle scattering technology. When used, it is preferred that luminescent copolymers, pigments or dyes are integrally incorporated into the article, e.g., a fiber or film, by mixing with the polymer matrix prior to or during the fiber spinning or film preparation process. It is most preferred that luminescent substances be incorporated by mixing with the polymer in a mixer, e.g., using a twin screw extruder having mixing elements, followed by, in the case of fibers, extrusion and spinning. As is known in the art, polymer film can similarly be produced by using a mixing and extrusion process.

The multiple luminescent responses obtainable by the use of light responsive additives are in one or more of the infrared, visible and ultraviolet regions of the spectrum. When the security article includes multiple luminescent responses, the peak intensities of such responses are separated in wavelength by at least about 20 nm; preferably by at least about 50 nm; more preferably by at least about 100 nm. It is most preferred that the multiple luminescent responses have peak wavelengths in at least two different regions of the spectrum. Preferably, the multiple luminescent responses are in regions of the spectrum selected from the infrared and visible regions, and the UV and visible regions. The multiple luminescent responses of the security articles of the present invention are excited by one or more illumination wavelengths selected from the infrared, the visible and the ultraviolet regions of the spectrum. Preferably, the luminescent responses are excited by one or more wavelengths in the infrared and the ultraviolet; the ultraviolet and the visible; and the infrared and the visible.

Luminescent pigments or dyes may be organic, inorganic or organometallic substances. Examples of thermally stable organic substances useful in the present invention are the compounds 4,4′-bis(2 methoxystyryl)-1′-biphenyl, 4,4′-bis (benzoaxazol-2-yl)stilbene, and 2,5-thiophenediylbis(5-tert-butyl-1,3-benzoxazole). Examples are compounds are sold commercially by Ciba Specialty Chemicals Inc. under the trade names UVITEX® FP, UVITEX® OB-ONE, and UVITEX®OB; and by Honeywell Specialty Chemicals under the tradename Lumilux® Effect Light Blue CO. These compounds, when excited by ultraviolet radiation, fluoresce in the ultraviolet and visible regions of the spectrum.

Examples of inorganic substances useful in the present invention are La₂O₂S:Eu, ZnSiO₄:Mn, and YVO₄:Nd. These materials are sold commercially by Honeywell Specialty Chemicals under the trade names LUMILUX® Red CD 168, LUMILUX® Green CD 145 and LUMILUX® IR-DC 139, respectively. Each is excited by ultraviolet radiation. LUMILUX® Red CD 168 and LUMILUX® Green CD 145 fluoresce in the visible and LUMILUX® IR-DC 139 fluoresces in the infrared. Another useful substance is a rare earth oxysulfide sold commercially by Honeywell Specialty Chemicals under the trade name LUMILUX® Red UC 6. This material is excited by infrared and fluoresces in the visible. Additionally, several zinc sulfide compounds doped with, e.g., silver, copper, aluminum or manganese are also sold commercially by Honeywell Specialty Chemicals. Several of these products are excited by UV and while light and respond with both fluorescence and phosphorescence and also are characterized as having the property of a long afterglow (Lumilux® Green N5, N-PM and N2); others are excited by UV radiation and fluoresce in colors including blue, green, red, yellow and yellow-orange (Lumilux® Effect: Blue A, Green A, Red A, Blue CO, Green CO Yellow CO and Yellow-Orange); still others are exicted by UV and white light and display fluorescence and phosphorescence (Lumilux® Effect Blue SN and Blue SN-F, alkaline earth silicates; Luminlux® Effect: Green N, Breen N-L, Green N-E, Green N-F, Green N-3F, Green N-FG, and Green N-FF); and Lumilux® Effect Red N 100, a calcium sulfide compound doped with europium and thulium, that is activated by white light and responds with red fluorescence and phosphorescence. Mixtures of such materials can also be used and some mixtures are available commercially (Lumilux® Effect Sipi: Yellow and Red).

Also useful are luminescent copolymers; such materials are disclosed in U.S. Pat. Nos. 3,668,189, 5,292,855 and 5,461,136. They are described as thermally stable copolyamides, copolyesters and copolyester-amides having fluorophoric compounds copolymerized therein. The copolymers of U.S. Pat. No. 5,292,855 are excited by and fluoresce at wavelengths in the near infrared region of the spectrum. The disclosures of these patents are incorporated herein by reference to the extent permitted.

Typically, fluorescent substances cease fluorescing virtually instantaneously, for example, in less than about a thousandth of a second, upon cessation of excitation. In contrast, phosphorescent substances may continue luminous emissions for some tens or hundreds of minutes after cessation of excitation. U.S. Pat. Nos. 5,424,006 and 5,674,437 describe a particular class of phosphorescent substances, and methods for their manufacture, that have long afterglow qualities and are useful in the security articles of the present invention since the rate of decay of luminescence can be used as one of the verifiable features of such articles. These patents are incorporated herein by reference to the extent permitted. U.S. Pat. No. 5,674,437 discloses incorporating such materials in fibers. The phosphorescent substances are generally described as doped metal aluminate oxide pigments, wherein the metal can be, e.g., calcium, strontium, barium or mixtures thereof and the dopants are preferably europium and an element selected from the group consisting of elements of the Lanthanide series of the Periodic Table of the Elements including lanthanum, cerium, praseodymium, neodymium, samarium, gadolinum, dysprysium, holmium, erbium, thulium, ytterbium and lutetium, and tin and bismuth. An example is SrAl₂O₄:Eu Dy, as described in U.S. Pat. No. 5,424,006; such pigments are available under the tradename Luminova® (United Mineral Corporation, NJ).

The luminescent substances can be used in concentrations suitable for obtaining a desired luminescent effect. In other words, depending on the particular end use or article for which security characteristics are desired, it may be desirable to used a mixture of fluorescent and phosphorescent substances or it may be desired to use solely a fluorescent substance or solely a phosphorescent substance. Taken together the concentration of luminescent substances in the matrix is at least about 0.05 weight percent; more preferably at least about 0.10 weight percent; still more preferably about 0.50 weight percent; for example, about 1.0 weight percent; typically about 2.5 weight percent. Conversely, the maximum concentration of one or more luminescent substances will be determined by the application, the physical properties of the article that need to be achieved, e.g., fiber strength, ease of fabrication, cost considerations, etc. Taken together the concentration of luminescent substances in the matrix is at most about 85 weight percent; more preferably at most about 50 weight percent; still more preferably about 25 weight percent; for example, about 20 weight percent; typically about 15 weight percent; for example at most about 10 weight percent. Useful ranges of the concentration of luminescent substances are obtained by combining the minimum and maximum values recited above. For example, a useful concentration of luminescent substances is from about 0.05 to about 85 weight percent; from about 0.05 to about 15 weight percent; from about 1.0 to about 20 weight percent; and the additional ranges based on permutations and combinations of the above values.

Security articles of the present invention that incorporate physical coloration based on particle scattering effects can be prepared by methods known in the art and discussed, for example, in commonly assigned U.S. Pat. No. 5,932,309, entitled “Colored Articles and Compositions and Methods for Their Production”, issued Aug. 3, 1999. Compositions based on this technology can be prepared by dispersing, for example, a non-absorbing particle scattering colorant into a matrix of, for example, a polymer or polymer mixture. Alternatively, an absorbing particle scattering colorant can be used, particularly one produced in situ, also as disclosed in the identified patent. In materials that exhibit physical coloring, light scattering is effected by particles that are dispersed within matrices that are at least partially light transmissive. The colorants useful for the present invention are called particle scattering colorants. Such colorants are distinguished from colorants that provide coloration due to the interference between light reflected from opposite parallel sides or interfaces of plate-like particles, called plate-like interference colorants, and those that provide coloration due to electronic transitions, called electronic transition colorants. While particle scattering colorants can provide a degree of coloration by electronic transitions, a colorant is a particle-scattering colorant if coloration depends on the size of the particles and there is no significant coloration from the interference of light reflected from opposite sides or interfaces of parallel plates.

Particle scattering colorants are either absorbing particle scattering colorants or non-absorbing particle scattering colorants depending on whether or not the particle scattering colorants significantly absorb light in the visible region of the spectrum. Absorption can be characterized as significant as evidenced by the visual perception of color when particle sizes are sufficiently large that particle scattering of light is not significant.

For a first category, a particle colorant is used by dispersing it in a solid matrix that has a substantially different refractive index in the visible than that of the particle scattering colorant. For this first category, a particle scattering colorant is defined as a material that has either the A or B property as defined below.

The A or B properties are determined by dispersing the candidate particle scattering colorant in a colorless isotropic liquid that has a refractive index that is as different from that of the candidate particle scattering colorant as is conveniently obtainable. The most reliable test will result from choosing the refractive index difference of the liquid and the candidate particle scattering colorant to be as large as possible. This liquid-solid mixture containing only the candidate particle scattering colorant and the colorless isotropic liquid is referred to as the particle test mixture. The negative logarithmic ratio of transmitted light intensity to incident light intensity (−log(I/Iₒ)) is measured for the particle test mixture as a continuous function of wavelength over a wavelength range that includes the entire visible spectral region from 380 to 750 nm. Such measurements, can be conveniently accomplished using an ordinary UV-visible spectrometer. The obtained quantity (−log(I/Iₒ)) is called the effective absorbance, since it includes the effects of both scattering and absorption on reducing the intensity of transmitted light.

The A property is only a valid determinant for particle scattering colorants for materials which do not significantly absorb in the visible region of the spectrum, which means that absorption is not so large as to overwhelm the coloration effects due to particle scattering. For the sole purpose of the A property test, a material that does not significantly absorb in the visible region is defined as one whose particle test mixture has an effective maximum absorbance in the spectral region of from about 380 to about 750 nm that decreases by at least about 2 times and preferably at least about 3 times when the average particle size of the candidate particle scattering colorant is increased to above about 20 microns without changing the gravimetric concentration of the candidate particle scattering colorant in the particle test mixture.

It should be understood that the above described ratios of absorbances will in general have a weak dependence on the concentration of the candidate particle scattering colorant in the particle test mixture. Such dependence is usually so weak as to be unimportant for the determination of whether or not a material is a particle scattering colorant. However, for cases where a material is only marginally a particle scattering colorant (or is marginally not a particle scattering colorant) the above described ratios of absorbances should be evaluated at the concentration of the candidate particle scattering colorant intended for materials application. Also, it will be obvious to one skilled in the art that the concentration of the candidate particle scattering colorant in the test mixture should be sufficiently high that I/Iₒ deviates significantly from unity, but not so high that I is too small to reliably measure.

A particle scattering colorant candidate that does not significantly absorb in the visible has the A property if the particle test mixture has an effective maximum absorbance in the spectral region of from about 380 to about 750 nm that is at least about 2 times and preferably at least about 3 times the effective minimum absorbance in the same wavelength range and the average particle size of the material is below about 20 microns.

If the candidate particle scattering colorant is significantly absorbing in the visible, it can alternatively be determined to be a particle scattering colorant if another material has the A property and that material does not significantly absorb in the visible and has substantially the same distribution of particle sizes and shapes as the candidate particle scattering colorant.

For scattering colorant candidates that significantly absorb in the visible, the B property is also suitable for determining whether or not a particulate material is a particle scattering colorant. The determination of whether or not the B property criterion is satisfied requires the same measurement of effective absorbance spectra in the visible region as used above. The B property criterion is satisfied if the candidate particle scattering colorant has a minimum in transmitted light intensity that is shifted at least by 10 nm compared with that obtained for the same composition having an average particle size above 20 microns.

In another embodiment, a colorant is formed when small particles, called primary particles are embedded within large particles. For this case, one can determine whether or not the candidate material is a particle scattering colorant by applying either the A property criterion or the B property criterion to either the primary particles or to the embedding particles that contain the primary particles.

These complexities in determining what is a particle scattering colorant disappear for embodiments of the second category, wherein the refractive index of a particle scattering colorant is matched to that of the matrix material at some wavelength in the visible. In such cases, any material that has a particle size less than 2000 microns is a particle scattering colorant. Likewise, the determination of whether or not a candidate is a particle scattering colorant is readily apparent when it comprises a two-dimensional or three-dimensional ordered array of primary particles. Large particles of such particle scattering colorants will have an opal-like iridescence that is apparent to the eye.

While the above determinations of whether or not a particulate material is a particle scattering colorant might seem complicated, they are quite simple and convenient to apply. Particulate materials are much easier to disperse in liquids than they would be to disperse in the solid matrices that provide the articles for use with this invention. Also, the measurements of effective absorbance required for applying either the A or B property criterion are rapid and can be accomplished by conventionally applied procedures using an inexpensive spectrometer. Hence, the application of these property criteria saves a great deal of time in the identification of materials (i.e., particle scattering colorants) that are suitable for the practice of this invention.

In certain embodiments, electronic transition colorants are used in conjunction with particle scattering colorants. An electronic transition colorant is defined as a material that has an absorption coefficient greater than 10⁻¹ cm⁻¹ at a wavelength in the visible and does not satisfy the criteria for a particle scattering colorant. Dyes and pigments are also used in conjunction with particle scattering colorants in embodiments of this invention. In this regard, a dye or pigment is defined as a material that absorbs light in the visible to a sufficient extent to confer visibly perceptible coloration. Depending on particle size, a pigment can either be a particle scattering colorant or an electronic transition colorant. Also, in general, either electronic transition colorants, dyes, or pigments can be used interchangeably in invention embodiments.

In use, the particle scattering colorants used in the present invention are dispersed as particles in a surrounding matrix. These particle scattering colorants particles can be either randomly located or arranged in a positionally correlated manner within a host matrix. In either case, intense coloration effects can occur as a consequence of scattering from these particles. A positionally correlated arrangement of particle scattering colorants is preferred in order to achieve coloration effects that are somewhat flashy, and in some cases provide dramatically different coloration for different viewing angles. Such scattering processes for arrays of particles that have translational order are referred to as Bragg scattering. Non-correlated particle scattering colorants are preferred in order to achieve more subtle coloration effects, which can be intense even for non-absorbing particle scattering colorants.

Since the visual limits of light radiation are approximately between 380 and 750 nm, these limits are preferred to define the optical characteristics of the particle scattering colorants for the purposes of the present invention. In some embodiments of the invention, the particle scattering colorants that are preferred have a refractive index that is different from that of the host matrix throughout the entire visible spectral range from 380 to 750 nm and particle scattering effects are preferably enhanced using electronic transition colorants, dyes or pigments. This situation differs from that of the Christiansen filter materials of the prior art that provide matching of the refractive indices of host and matrix materials at least at one wavelength in the visible, and electronic transition colorants, dyes or pigments usually degrade performance. Unless otherwise specified, the described refractive indices are those measured at room temperature. Also, a particle scattering colorant is said to have a different refractive index, a lower refractive index, or a higher refractive index than a matrix material if there exists a light polarization direction for which this is true.

The particle scattering colorants, or a subcomponent thereof, should be small enough to effectively scatter light chromatically. If there does not exist a visible wavelength at which a refractive index of the scattering particle colorant and the matrix are substantially matched, this means that the average particle size of such colorants is preferably less than about 2 microns in the smallest dimension. By average particle size we mean the ordinary arithmetic average, rather than (for example) the root-mean-square average. For embodiments of this invention where chromatic coloration occurs as a consequence of the existence of a large difference between the refractive index of the matrix and the particle scattering colorant throughout the visible spectral region, the average particle size for the particle scattering colorants is more preferably from about 0.01 to about 0.4 microns. In this case the average particle size in the smallest dimension is most preferably less than about 0.2 microns. Especially if the particle scattering colorant significantly absorbs light in the visible, even smaller average particle sizes of less than 0.01 microns are within the preferred range. Also, if the particle scattering colorant particles are not preferentially oriented, it is preferable that the average ratio of maximum dimension to minimum dimension for individual particles of the particle scattering colorant is less than about four and that the particle scattering colorant particles have little dispersion in either particle size or shape. On the other hand, for embodiments of this invention in which the refractive index of the particle scattering colorant and the matrix substantially vanishes at a visible wavelength, particle shapes can be quite irregular and preferred average particle sizes can be quite large, preferably less than about 2000 microns. Even larger particle sizes can be in the preferred range if the particle scattering colorant contains smaller particle scattering colorants within it. This complicated issue of preferred particle sizes for different embodiments of the invention will be further clarified in the discussion of these embodiments hereinafter.

Instead of expressing particle sizes by an average particle size or an average particle size in the smallest dimension, particle size for a particular particle scattering colorant can be expressed as the fraction of particles that have a smallest dimension that is smaller than a described limit. Such description is most useful for the embodiments of this invention where the refractive index of the particle scattering colorant is much different than that of the matrix at all wavelengths in the visible. In such embodiments, it is preferable that at least about 50% of all particles have a smallest dimension that is less than about 0.2 microns.

The matrix in which the particle scattering colorant is dispersed can be either absorbing or non-absorbing in the visible spectral range. This absorption characteristic can be specified using either path-length-dependent or path-length-independent quantities for characterization. For example, if an initial light intensity Iₒ is reduced to Iₜ by absorptive processes after the light passes through a matrix thickness t, then the percent transmission is 100 (Iₜ/Iₒ) . The corresponding absorption coefficient is −(1/t)ln(Iₜ/Iₒ) . Unless otherwise specified, the described absorption characteristics are those for a light polarization direction for which there is least absorption of light. For certain applications it is preferable for the particle scattering colorant to be substantially non-absorbing in the visible region. For other applications it is sufficient for the particle scattering colorant to not have a highest peak in absorption peak within the visible. In other applications that will be described, it is preferable for the particle scattering colorant to have a maxima in absorption coefficient at wavelengths that are within the visible. The latter provides invention embodiments in which the particle scattering colorant contains an overcoating layer of an absorbing material that is sufficiently thin that it produces little light absorption.

Light scattering that is not strongly frequency dependent in the visible region will often occur as a result of imperfections in a matrix material. One example of such imperfections are crystallite-amorphous boundaries in semi-crystalline polymeric matrix materials. Such non-chromatic scattering can interfere with the achievement of coloration using particle scattering colorants. Consequently, it is useful to define the “effective absorption coefficient” using the above expressions, without correction for the scattering of the matrix that does not arise from the particle scattering colorants.

Because of their utility for the construction of various articles for which novel optical effects are desired, such as upc codes, security markings and molded parts, useful matrix materials for the compositions of this invention include cellulosic compositions such as paper, and organic polymers. For purposes of the present invention, the term polymers includes homopolymers, copolymers, and various mixtures thereof. Various inorganic and mixed organic and inorganic matrix materials are also suitable for use as matrix materials, particularly for the particle scattering technology, such as SiO₂ glasses, and mixtures of inorganic and organic polymers. The principal limitation on the choice of such matrix materials is that either absorption or wavelength insensitive light scattering are not so dominant that the wavelength-selective scattering (i.e., chromatic scattering) due to particle scattering colorants is negligible. This limitation means that such matrix materials must have a degree of transparency. Using the above defined effective absorption coefficient, this requirement of transparency means that the effective absorption coefficient for the host matrix in which the particle scattering colorant particles are dispersed is preferably less than about 10⁻⁴ Å⁻¹ at some wavelength in the visible spectra. More preferably, this effective absorption coefficient of the host matrix is less than about 10⁻⁵ Å⁻¹ at some wavelength in the visible, and most preferably this effective absorption coefficient is less than about 10⁻⁶ Å⁻¹ at some wavelength in the visible. Numerous commercially available transparent organic polymers having lower effective absorption coefficients in the visible are especially suitable for use as matrix materials for the present invention. These include, for example, polyamides, polyurethanes, polyesters, polyacrylonitriles, and hydrocarbon polymers such as polyethylene and polypropylene. Amorphous polymers having very little scattering due to imperfections are especially preferred, such as an optical quality polyvinyl, acrylic, polysulfone, polycarbonate, polyarylate, or polystyrene.

Depending on the intensity of coloration desired, the loading level of the particle scattering colorant in the host matrix can be varied over a very wide range. As long as the particle scattering colorants do not become aggregated to the extent that large refractive index fluctuations are eliminated at interfaces between particles, the intensity of coloration will generally increase with the loading level of the particle scattering colorant. However, very high loading levels of the particle scattering colorant can degrade mechanical properties and intimate particle aggregation can dramatically decrease interfacial refractive index changes and alter the effective dimensions of scattering particles. For this reason the volumetric loading level of the particle scattering colorant in the host matrix is preferably less that about 70%, more preferably less than about 30%, and most preferably less than about 10%. However, in order to obtain a significant coloration effect, the particle scattering colorant preferably comprises at least about 0.01 weight percent of the matrix component; more preferably at least about 0.1 weight percent of the matrix component; and most preferably at least about 1.0 weight percent of the matrix component. Also, the required loading levels of particle scattering colorants can be lower for absorbing particle scattering colorants than for non-absorbing particle scattering colorants, and can be decreased in certain embodiments of the invention as either the refractive index difference between matrix and particle scattering colorant is increased or the thickness of the matrix containing the particle scattering colorant is increased.

Various methods of particle construction can be employed in the materials of the present invention for achieving the refractive index variations that are necessary in order to obtain strong particle scattering. Preferred methods include (1) the simple particle method, (2) the surface-enhanced particle method, and (3) the onion-skin particle method. In the simple particle method, the particles are substantially uniform in composition and the refractive index of these particles is chosen to be different from that of the host matrix. Unless otherwise noted, comments made herein regarding the refractive index differences of particles and host matrices pertain either to the particle refractive index for the simple particle method or the outer particle layer for the case of more complex particles. In the surface-enhanced particle method, the particles contain an overcoat of an agent that has a refractive index which is different from that of the matrix. The refractive indices of the surface enhancement agent and the host matrix should preferably differ by at least about 5%. More preferably, this refractive index difference is greater than about 25%. Finally, in the onion-skin particle method, the scattering particles are multi-layered (like an onion skin) with layers having different refractive indices, so that scattering occurs from each interface between layers. This refractive index difference is preferably greater than about 5%, although smaller refractive index differences can be usefully employed if a large number of layers are present in the onion-skin structure.

In one embodiment for the simple particle method, the refractive index of the scattering particles is higher than that of the matrix. In another embodiment the refractive index of the matrix is higher than that of the scattering particles. In both these embodiments the difference in refractive indices of the scattering centers and the matrix should be maximized in order to enhance coloration due to particle scattering. Hence, these embodiments are referred to as large Δn embodiments. More specifically, in the case where the scattering centers are inorganic particles and the matrix is an organic polymer, the difference in refractive index between the inorganic particles and the organic polymer should be maximized. This refractive index difference will generally depend on the direction of light polarization.

In other embodiments, the refractive index of the particle scattering colorants are closely matched at least at one wavelength in the visible. In these embodiments it is preferred that (1) there is a large difference in the wavelength dependence of the refractive index of the particle scattering colorant and the matrix polymer in the visual spectral region, (2) the matrix polymer and the particle scattering colorant have states that are optically isotropic, and (3) the neat matrix polymer has a very high transparency in the visible. Such embodiments, called vanishing Δn embodiments, use the concept of the Christiansen filter to obtain coloration. The size of the particle scattering colorants are chosen so that all wavelengths in the visible region are scattered, except those in the vicinity of the wavelength at which the refractive index of the matrix and the particle scattering colorant are matched. This wavelength dependence of scattering efficiency either provides or enhances the article coloration.

Both the high Δn embodiments and the vanishing Δn embodiments provide the means for obtaining either stable coloration or switchable coloration. In the high Δn embodiments, coloration that is switchable in a desired manner is preferably achieved using the combined effects of particle scattering and a wavelength-dependent absorption in the visible that is associated with an electronic transition. In the vanishing Δn embodiments, coloration that is switchable in a desired manner can be achieved by effects (light or actinic radiation exposure, thermal exposure, electric fields, temperature, humidity, etc.) that either (1) shift the wavelength at which Δn vanishes between two wavelengths within the visible range, (2) shift the wavelength at which Δn vanishes to within the visible range, (3) shift the wavelength at which Δn vanishes to outside the visible range, or (4) causes a shift in coloration due to combined effects of particle scattering and chromism in absorption in the visible that is associated with an electronic transition colorant, dye or pigment. Ferroelectric, switchable antiferroelectric compositions, and photoferroelectric compositions provide preferred compositions for obtaining switchable coloration using particle scattering colorants.

Electronic transition colorants, dyes or pigments are especially preferred for obtaining switchable coloration for the high Δn embodiments, even when such colorants do not undergo a switching of electron absorption coloration. The reason can be seen by considering a material (such as a polymer film) that is sufficiently thin that particles do not scatter all of the incident visible radiation. In this case of the high Δn embodiment, the difference in refractive index of the particle scattering colorants and the matrix is large over the entire visible spectral range (compared with the wavelength dependence of Δn over this range). Hence, changes in the refractive index difference between particle scattering colorant and matrix increases the overall intensity of scattered light, which is generally approximately exponentially proportional to (Δn)², but does not substantially change the wavelength distribution of such scattered light. On the other hand, the chromatic reflection and absorption of an electronic transition absorption colorant can provide switchability in the chromatic nature of scattered light, since the amount of incident light effected by the electronic transition colorant, dye or pigment can depend upon the amount of light that is not scattered by the particle scattering colorant. As an example, one may think of the situation where the scattering effectiveness and thickness of a particle scattering colorant layer is so great that substantially no light is transmitted through to a layer containing an electronic transition colorant. If the refractive index of the particle scattering colorant is then switched so that the refractive index of the particle scattering colorant becomes much closer to that of the matrix, then light can be substantially transmitted through the particle scattering colorant layer to the electronic transition colorant layer. Then a switchability in the refractive index of the particle scattering colorant provides a switchability in the coloration of the article. This situation is quite different from the case of the vanishing Δn embodiment, where, even in the absence of an electronic absorption, an article that is sufficiently thin that it does not completely scatter light can evidence a switchability in the chromatic nature of scattered light. This can be true as long as there is a switchability in the wavelength in the visible at which Δn vanishes and Δn significantly depends upon wavelength in the visible. The wavelength dependence of refractive index in the visible is usefully provided as either n_{F}−n_{C} or the Abbe number ((n_{D}−1)/(n_{F}−n_{C})), where the subscripts F, D, and C indicate the values of the refractive index at 486.1, 589.3, 656.3 nm, respectively. For the purpose of obtaining enhanced coloration for the vanishing Δn embodiment, the difference in n_{F}−n_{C} for the particle scattering colorant and the matrix in which this colorant is dispersed is preferably greater in absolute magnitude than about 0.001.

Particle scattering colorants and electronic transition colorants can either be commingled together in the same matrix or mingled in separate matrices that are assembled so as to be either substantially mutually interpenetrating or substantially mutually non-interpenetrating. The latter case, where the particle scattering colorant and the electronic scattering colorant are in separate matrices that are substantially mutually non-interpenetrating, provides a more preferred embodiments, since the total intensity of light scattered by the particle scattering colorant can thereby be optimized. In this type of embodiment, the matrix containing the particle scattering colorant is preferably substantially exterior to that containing the electronic transition colorant on at least one side of a fashioned article. So that the effects of both a electronic transition colorant and a non-absorbing particle scattering colorant can be perceived, the thickness of the matrix containing the particle scattering colorant should be such that there exists a wavelength of visible light where from about 10% to about 90% light transmission occurs through the particle scattering colorant matrix layer, so as to reach the electronic transition colorant matrix layer. The preferred thickness of the electronic absorption colorant containing matrix layer that underlies the particle scattering colorant containing layer (tₑ) depends upon the absorption coefficient of the electronic transition colorant at the wavelength in the visible at which the maximum absorption occurs (λₘ), which is called αₑ, and the volume fraction of the matrix that is the electronic transition colorant (Vₑ). Preferably, αₑ tₑ Vₑ is greater than 0.1, which corresponds to a 9.5% absorption at λₘ. Likewise, for the embodiments where the particle scattering colorant and the electronic absorption colorant are commingled in the same phase, it is useful to define analogous quantities for the particle scattering colorant (which are denoted by the subscripts s), the only difference being αₛ for the particle scattering colorant includes the effects of both light absorption and light scattering on reducing the amount of light transmitted through the material and αₛ depends on particle size. For these embodiments αₑ Vₑ and αₛ Vₛ preferably differ by less than a factor of about ten, and more preferably by a factor of less than about three. Likewise, preferred embodiments can be expressed for the case of where the particle scattering colorant and the electronic transition colorant are located in separate phases (with volumes vₛ and vₑ, respectively) that are substantially mutually interpenetrating. In this case, αₑ vₑ Vₑ and αₑ vₛ Vₛ preferably differ by less than about a factor of ten, and more preferably by a factor of less than about three.

The variation in refractive indices with composition for organic polymers is relatively small compared with the corresponding variation for inorganic particles. Typical average values for various unoriented organic polymers at 589 nm are as follows: polyolefins (1.47-1.52), polystyrenes (1.59-1.61), polyfluoro-olefins (1.35-1.42), non-aromatic non-halogenated polyvinyls (1.45-1.52), polyacrylates (1.47-1.48), polymethacrylates (1.46-1.57), polydienes (1.51-1.56), polyoxides (1.45-1.51), polyamides (1.47-1.58), and polycarbonates (1.57-1.65). Especially preferred polymers for use as polymer host matrices are those that have little light scattering in the visible due to imperfections, such as polymers that are either amorphous or have crystallite sizes that are much smaller than the wavelength of visible light. The latter polymers can be obtained, for example, by rapid melt-quenching methods.

Preferred scattering particles for combination in composites with polymers having such low refractive indices in high Δn embodiments are high refractive index materials such as: 1) metal oxides such as titanium dioxide, zinc oxide, silica, zirconium oxide, antimony trioxide and alumina; 2) carbon phases such as diamond (n about 2.42), Lonsdaleite, and diamond-like carbon; 3) other high refractive index inorganics such as bismuth oxychloride (BiOCl), barium titanate (nₒ between 2.543 and 2.339 and nₑ between 2.644 and 2.392 for wavelengths between 420 and 670 nm), potassium lithium niobate (nₒ between 2.326 and 2.208 and nₑ between 2.197 and 2.112 for wavelengths between 532 and 1064 um), lithium niobate (nₒ between 2.304 and 2.124 and nₑ between 2.414 and 2.202 for wavelengths between 420 and 2000 nm), lithium tantalate (nₒ between 2.242 and 2.112 and nₑ between 2.247 and 2.117 for wavelengths between 450 and 1800 nm), proustite (nₒ between 2.739 and 2.542 and nₑ between 3.019 and 2.765 for wavelengths between 633 and 1709 nm), zinc oxide (nₒ between 2.106 and 1.923 and nₑ between 2.123 and 1.937 for wavelengths between 450 and 1800 nm), alpha-zinc sulfide (nₒ between 2.705 and 2.285 and nₑ between 2.709 and 2.288 for wavelengths between 360 and 1400 nm), and beta-zinc sulfide (nₒ between 2.471 and 2.265 for wavelengths between 450 and 2000 nm). High refractive index organic phases are also preferred as particle scattering colorants for use in low refractive index phases. An example of a high refractive index organic phase that can be used as a particle scattering colorant with a low refractive index organic matrix phase (such as a polyfluoro-olefin) is a polycarbonate or a polystyrene. As is conventional, nₒ and nₑ in the above list of refractive indices denote the ordinary and extraordinary refractive indices, respectively, for crystals that are optically anisotropic. The nₒ refractive index is for light propagating down the principal axis, so there is no double refraction, and the nₑ refractive index is for light having a polarization that is along the principal axis.

For the case where a high refractive index matrix is needed in conjunction with low index scattering particles, preferred particle scattering colorants are 1) low refractive index materials, such as fluorinated linear polymers, fluorinated carbon tubules, fluorinated graphite, and fluorinated fullerene phases, 2) low refractive index particles such as cavities filled with air or other gases, and 3) low refractive index inorganic materials such as either crystalline or amorphous MgF₂. Various inorganic glasses, such as silicate glasses, are preferred for use as particle scattering colorants in many organic polymer matrices for the vanishing Δn embodiments. The reason for this preference is that such glasses are inexpensive and can be conveniently formulated to match the refractive index of important, commercially available polymers at one wavelength in the visible. Also, the dispersion of refractive index for these glasses can be quite different from that of the polymers, so that substantial coloration effects can appear in particle scattering. Inorganic glasses are also preferred for use in high Δn embodiments, although it should be clear that the host matrix chosen for a high Δn embodiment for particular glass particles must have either a much higher or a much lower refractive index than the matrix chosen for a vanishing Δn embodiment for the same glass particles. For example a glass having a refractive index of 1.592 would be a suitable particle scattering colorant for polystyrene in the vanishing Δn embodiment, since polystyrene has about this refractive index. On the other hand, poly(heptafluorobutyl acrylate), with refractive index of 1.367 could be used with the same glass particles in a high Δn embodiment. Relevant for constructing these colorant systems, note that the refractive indices of common glasses used in optical instruments range from about 1.46 to 1.96. For example, the refractive indices of ordinary crown, borosilicate crown, barium flint, and light barium flint extend from 1.5171 to 1.5741 and the refractive indices of the heavy flint glasses extend up to about 1.9626. The values of n_{F}−n_{C} for these glasses with refractive indices between 1.5171 and 1.5741 range between 0.0082 and 0.0101. The corresponding range of the Abbe number is between 48.8 and 59.6. A refractive index that is on the lower end of the above range for commonly used optical glasses is obtained for fused quartz, and this material is also a preferred particle scattering colorant. The refractive index for fused quartz ranges from 1.4619 at 509 nm to 1.4564 at 656 nm.

Ferroelectric ceramics (such as the above mentioned barium titanate and solid solutions of BaTiO₃ with either SrTiO₃, PbTiO₃, BaSnO₃, CaTiO₃, or BaZrO₃) are preferred compositions for the particle scattering colorant phase of the compositions of the present invention. The reason for this preference is two-fold. First, very high refractive indices are obtainable for many such compositions. For high Δn embodiments, these high refractive indices can dramatically enhance coloration via an enhancement in scattering due to the large refractive index difference with respect to that of the matrix phase. Second, if matrix and host phases are matched in refractive index at a particular wavelength in the absence of an applied field (as for the vanishing Δn embodiments), an applied electric field can change the wavelength at which this match occurs—thereby providing a switching of color state. Alternatively, a ferroelectric phase that is an organic polymer can be selected to be the host phase. If a particle phase is again selected to match the refractive index of the unpoled ferroelectric at a particular wavelength, the poling process can introduce an electrically switched change in coloration. Such matching of the refractive index of host phase and particle scattering colorant can be one that exists only for a specified direction of light polarization. However, it is most preferred that the matrix material and the particle scattering colorant have little optical anisotropy, so that the match of refractive indices is largely independent of light polarization direction.

Ceramics that are relaxor ferroelectrics are preferred ferroelectrics for use as particle scattering colorant phases. These relaxor ferroelectrics have a highly diffuse transition between ferroelectric and paraelectric states. This transition is characterized by a temperature Tₘ, which is the temperature of the frequency-dependent peak in dielectric constant. As is conventional, we herein call Tₘ the Curie temperature (T_{c}) of a relaxor ferroelectric, even though such ferroelectrics do not have a single transition temperature from a purely ferroelectric state to a purely paraelectric state. Relaxor ferroelectrics are preferred ferroelectrics for use as particle scattering colorants when electric-field-induced switching in coloration is desired, since such compositions can display very large field-induced changes in refractive indices. Since these field-induced refractive index changes generally decrease as particle diameters become small, the particle dimensions should be selected to be as large as is consistent with achieving desired coloration states.

Relaxor ferroelectrics that are preferred for use in the present invention have the lead titanate type of structure (PbTiO₃) and disorder on either the Pb-type of sites (called A sites) or the Ti-type of sites (called B sites). Examples of such relaxor ferroelectrics having B site compositional disorder are Pb(Mg_{1/3} Nb_{2/3})O₃ (called PMN), Pb(Zn_{1/3} Nb_{2/3})O₃ (called PZN), Pb(Ni_{1/3} Nb_{2/3})O₃ (called PNN), Pb(Sc_{1/2} Ta_{1/2})O₃, Pb(Sc_{1/2} Nb_{1/2})O₃ (called PSN), Pb(Fe_{1/2} Nb_{1/2})O₃ (called PFN), and Pb(Fe_{1/2} Ta_{1/2})O₃. These are of the form A(BF_{1/3}BG_{2/3})O₃ and A(BF_{1/2} BG_{1/2})O₃, where BF and BG represent the atom types on the B sites. Further examples of relaxor ferroelectrics with B-site disorder are solid solutions of the above compositions, such as (1−x)Pb(Mg_{1/3} Nb_{2/3})O₃-xPbTiO₃ and (1−x)Pb(Zn_{1/3} Nb_{2/3})O₃-xPbTiO₃. Another, more complicated, relaxor ferroelectric that is preferred for use in the present invention is Pb₁₋ₓ²⁺ Laₓ³⁺ (Zr_{y} Ti_{z})_{1-x/4}O₃, which is called PLZT. PZT (lead zirconate titanate, PbZr₁₋ₓ Tiₓ O₃) is an especially preferred ferroelectric ceramic for use as a particle scattering colorant. PMN (lead magnesium niobate, Pb(Mg_{1/3} Nb_{2/3})O₃) is another especially preferred material, which becomes ferroelectric below room temperature. Ceramic compositions obtained by the addition of up to 35 mole percent PbTiO₃ (PT) to PMN are also especially preferred for use as a particle scattering colorant, since the addition of PT to PMN provides a method for varying properties (such as increasing the Curie transition temperature and varying the refractive indices) and since a relaxor ferroelectric state is obtainable using up to 35 mole percent of added (i.e., alloyed) PT.

Ceramic compositions that undergo a field-induced phase transition from the antiferroelectric to the ferroelectric state are also preferred for obtaining composites that undergo electric-field-induced switching of coloration. One preferred family is the Pb_{0.97} La_{0.02} (Zr, Ti, Sn)O₃ family that has been found by Brooks et al. (Journal of Applied Physics 75, pp. 1699-1704 (1994)) to undergo the antiferroelectric to ferroelectric transition at fields as low as 0.027 MV/cm. Another family of such compositions is lead zirconate-based antiferroelectrics that have been described by Oh et al. in “Piezoelectricity in the Field-Induced Ferroelectric Phase of Lead Zirconate-Based Antiferroelectrics”, J. American Ceramics Society 75, pp. 795-799 (1992) and by Furuta et al. in “Shape Memory Ceramics and Their Applications to Latching Relays”, Sensors and Materials 3,4, pp. 205-215 (1992). Examples of known compositions of this type, referred to as the PNZST family, are of the general form Pb_{0.99} Nb_{0.02} [(Zr_{0.6} Sn_{0.4})_{1-y} Ti_{y}]_{0.98} O₃. Compositions included within this family display field-induced ferroelectric behavior that is maintained even after the poling field is removed. Such behavior is not observed for Type I material (y=0.060), where the ferroelectric state reconverts to the antiferroelectric state when the field is removed. However, type II material (y=0.63) maintains the ferroelectric state until a small reverse field is applied and the type III material (y=065) does not revert to the antiferroelectric state until thermally annealed at above 50° C. Reflecting these property differences, the type I material can be used for articles that change coloration when an electric field is applied, and revert to the initial color state when this field is removed. On the other hand, the type II and type III materials can be used to provide materials in which the electric-field-switched color state is stable until either a field in the reverse direction is applied or the material is thermally annealed.

Ferroelectric polymer compositions are suitable for providing either the particle scattering colorant or the matrix material for a composite that is electrically switchable from one color state to another. The term ferroelectric polymer as used herein includes both homopolymers and all categories of copolymers, such as random copolymers and various types of block copolymers. This term also includes various physical and chemical mixtures of polymers. Poly(vinylidene fluoride) copolymers, such as poly(vinylidene fluoride-trifluoroethylene), P(VDF-TrFE), are preferred ferroelectric polymer compositions. Additional copolymers of vinylidene fluoride useful for the composites of the present invention are described by Tournut in Macromolecular Symposium 82, pp. 99-109 (1994). Other preferred ferroelectric polymer compositions are the copolymers of vinylidene cyanide and vinyl acetate (especially the equal mole ratio copolymer) and odd nylons, such as nylon 11, nylon 9, nylon 7, nylon 5, nylon 3 and copolymers thereof.

Other particle scattering colorants include those that are absorbing particle scattering colorants. One preferred family of such absorbing particle scattering colorants are colloidal particles of metals (such as gold, silver, platinum, palladium, lead, copper, tin, zinc, nickel, aluminum, iron, rhodium, osmium, iridium, and alloys, metal oxides such as copper oxide, and metal salts). Preferably the particles are less than about 0.5 micron in average dimension. More preferably the particles are less than about 0.1 microns in average dimension. In order to achieve special coloration effects, particles are most preferred that are less than about 0.02 microns in average dimension. Particles that have colloid-like dimensions are herein referred to as colloidal particles, whether or not colloid solutions can be formed. Particle sizes that are below about 0.02 microns are especially useful for obtaining a wide range of coloration effects from one composition of absorbing particle scattering colorant, since these small sizes can provide particle refractive indices and absorption coefficient maxima that depend upon particle size. This size variation of the wavelength dependent refractive index and absorption coefficient is most strongly enhanced for particles that are sometimes referred to as quantum dots. Such quantum dot particles preferably have a narrow particle size distribution and an average particle size that is from about 0.002 to about 0.010 microns.

Convenient methods for forming colloidal particles include the various methods well known in the art, such as reaction of a metal salt in a solution or the crystallization of materials in confined spaces, such as solid matrices or vesicles. Likewise, well-known methods for producing colloidal particles can be employed wherein colloid size liquid or solid particles dispersed in a gas or a vacuum are either reacted or otherwise transformed into solid particles of desired composition, such as by crystallization. As an example of formation of colloidal particles that are useful for the present invention by solution reaction methods, note that Q. Yitai et al. have described (in Materials Research Bulletin 30, pp. 601-605 (1995)) the production of 0.006 micron diameter zinc sulfide particles having a very narrow particle distribution by the hydrothermal treatment of mixed sodium sulfide and zinc acetate solutions. Also, D. Daichuan et al. have reported (in Materials Research Bulletin 30, pp. 537-541 (1995)) the production of uniform dimension colloidal particles of beta-FeO(OH) by the hydrolysis of ferric salts in the presence of urea using microwave heating. These particles had a rod-like shape and a narrow size distribution. Using a similar method (that is described in Materials Research Bulletin 30, pp. 531-535 (1995)), these authors have made colloidal particles of alpha-FeO having a uniform shape (and dimensions) that can be varied from a tetragonal shape to close to spherical (with an average particle diameter of about 0.075 microns). T. Smith et al. report the production of colloidal particles in commonly-assigned U.S. Pat. No. 5,932,309, wherein the colloidal particles are prepared in situ by adding a metal salt, such as gold (III) chloride to a polymer, such as nylon 6, blending and extruding the mixture. Additionally this patent discloses the generation of colloids in solution and in the solid state with metal salts, such as gold (III) chloride, in the presence of reducing agents, such as trisodium citrate. Fiber-like particle scattering colorants having a colloid-like size in at least two dimensions are also preferred for certain invention embodiments, especially where anisotropic coloration effects are desired. One unusual method for forming very small fibers that can be used as particle scattering colorants is by the deposition of a material within the confining space of a hollow nano-scale fiber. The particle scattering colorant can then either comprise the filled nano-scale diameter fiber, or the fiber of the filler that is obtained by removing (by either physical or chemical means) the sheath provided by the original hollow fiber. The general approach of making such fibers by the filling of nano-size hollow fibers is taught, for example, by V. V. Poborchii et al. in Superlattices and Microstructures, Vol. 16, No. 2, pp. 133-135 (1994). These workers showed that about 6 nm diameter nano-fibers can be obtained by the injection and subsequent crystallization of molten gallium arsenide within the 2 to 10 nm channels that are present in fibers of chrysotile asbestos. An advantage of such small dimension particles, whether in fiber form or not, is that the quantum mechanical effects provide refractive indices and electronic transition energies that strongly depend upon particle size. Hence, various different coloration effects can be achieved for a particle scattering colorant by varying particle size. Also, high dichroism in the visible can be obtained for colloidal fibers of metals and semiconductors, and such high dichroism can result in novel visual appearances for articles that incorporate such fibers as particle scattering colorants.

Colloidal particle scattering colorants, as well as particle scattering colorants that have larger dimensions, that comprise an outer layer that absorbs in the visible are among preferred particle scattering colorants for use in high Δn embodiments. In such high Δn embodiments there is a large refractive index difference between the particle scattering colorant and the matrix in the visible wavelength range. The reason for this preference is that a very thin layer of a visible-light-absorbing colorant on the outside of a colorless particle scattering colorant can dramatically enhance scattering at the particle-matrix interface, while not substantially increasing light absorption. In order to achieve the benefits of such particle scattering colorant configuration, it is preferred that (1) the coating of the visible-light-absorbing colorant on the surface of the particle scattering colorant comprises on average less than 50% of the total volume of the particles of the particle scattering colorant, (2) the average particle size of the particle scattering colorant is less that 2 microns, and (3) the refractive index of the coating of the particle scattering colorant differs from that of the matrix in which the particle scattering particle is dispersed by at least 10% at visible wavelengths. More preferably, the coating of the visible-light-absorbing colorant on the surface of the particle scattering colorant comprises on average less than about 20% of the total volume of the particles of the particle scattering colorant and the average particle size of the particle scattering colorant is less that 0.2 microns. Preferred applications of such surface-enhanced particle scattering colorants are for coatings, polymer fibers, polymer films, and polymer molded articles. A method for the fabrication of colloidal particles containing a visible-light-absorbing colorant on the surface of a colorless substrate particle is described by L. M. Gan et al. in Materials Chemistry and Physics 40, pp. 94-98 (1995). These authors synthesized barium sulfate particles coated with a conducting polyaniline using an inverse microemulsion technique. The sizes of the composite particles (from about 0.01 to 0.02 microns) are convenient for the practice of the high Δn embodiments of the present invention.

Colloid particles can either be added to the matrix in the colloid-form or the colloid particles can be formed after addition to the matrix. Likewise, these processes of colloid formation and dispersion can be accomplished for a precursor for the matrix, which is subsequently converted to the matrix composition by chemical processes, such as polymerization. For example, if the matrix is an organic polymer, such as nylon, the metal colloids can be formed in a liquid, mixed with the ground polymer, and heated above the melting point of the polymer to produce nylon colored with particle scattering colorants. On the other hand, either colloidal metal particles or a precursor thereof can be added to the monomer of the polymer, the colloid particles can be formed in the monomer, and the monomer can then be polymerized. A precursor for a metal colloid can also be added to the polymer matrix and the colloidal particles can be then formed in a subsequent step. Such processes of colloidal particle formation and incorporation can be facilitated by using a melt, dissolved, gel, or solvent-swollen state of the polymer (or a precursor thereof) during colloid incorporation, colloid formation, or colloid formation and incorporation. Alternatively, high energy mechanical commingling involving a solid state of the polymer (or a precursor thereof) can be used to accomplish colloid incorporation, colloid formation, or colloid formation and incorporation.

The incorporation of colloidal size particle scattering colorants in the gel state of a polymer prior to the formation of said gel state into a polymer fiber provides an additional preferred embodiment. For these processes, the particle scattering colorant should preferably have a refractive index that is at least 10% different from that of the solid polymer matrix of the fiber at a wavelength in the visible. The average particle size of the particle scattering colorant is preferably less than about 0.2 microns, more preferably less than about 0.08 microns, and most preferably less than about 0.02 microns. For particle sizes of less than about 0.02 microns, the particle scattering colorants preferably significantly absorbs in the visible. For the case where the particle scattering colorant is substantially non-absorbing in the visible, the polymer fiber preferably comprises an electronic transition colorant that is commingled with the particle scattering colorant in the gel state. Preferably this electronic transition colorant is substantially a black carbon form, such as carbon black, and the particle scattering colorant comprises an inorganic composition. So as not to interfere with fiber strength, both the particle scattering colorant and optional electronic transition colorant particle used for these fibers should have very small dimensions, preferably less than about 0.02 microns. Such embodiments solve a long standing problem that arises for the coloration of high strength fibers that are spun in the gel state, such as high molecular weight polyethylene that is spun from a mineral oil gel. This problem is that conventional organic dyes or pigments can interfere with the formation of high quality product from the gel state. An important example of a high strength fiber product spun from the gel state is Spectra® polyethylene fiber made by Honeywell International (formerly AlliedSignal). These fibers, which are gel processed at high temperatures, are widely used for fishing lines, fishing nets, sails, ropes, and harnesses.

Ultrafine metal particles suitable for use as particle scattering colorants can be located on the surface of much larger particles that are themselves particle scattering colorants. Combined particle scattering colorants of this form are also suitable for use in the present invention. Methods for the preparation of such particle scattering colorants, where metal particles are deposited on much larger polymer particles, are provided by H. Tamai et al. in the Journal of Applied Physics 56, pp. 441-449 (1995). As another alternative, colloidal particle scattering colorants can be located within larger particles that, depending upon their dimensions and refractive index in the visible (relative to the matrix) can additionally provide particle scattering coloration. In any case, the larger particles are referred to as particle scattering colorants as long as the included particles are particle scattering colorants. In a preferred case, the colloidal particles are metal or metal alloy particles in a glass matrix. Methods for obtaining colloidal copper dispersed in SiO₂-comprising glass are described in the Journal of Non-crystalline Solids 120, pp. 199-206 (1990) and methods for obtaining silicate glasses containing colloidal particles of various metals, including gold and silver, are described in U.S. Pat. Nos. 2,515,936; 2,515,943, and 2,651,145, which are incorporated herein by reference. These glasses containing colloidal particle scattering colorants are transformed to particles, such as by grinding or melt processes, and can be used as particle scattering colorants. In such embodiments, these particle scattering colorants are preferably dispersed in a polymer matrix, thereby providing particle scattering coloration for articles consisting of the resulting polymer composite.

An advantage of this colloid-within-particle design of the particle scattering colorant is that the glass particles can stabilize the colloidal particles with respect to degradation processes, such as oxidation. A second advantage is that high temperature methods can be used for forming the colloid in the glass, which could not be used for the dispersion of the colloidal particles directly in an organic polymer matrix. A third advantage of the colloid-within-particle method is that the processes of colloid formation and dispersion are separated from the processes of dispersion of the particle scattering colorant in the final polymer matrix, which can provide improved process economics. A fourth advantage is that the particle matrix can be tailored to respond to electric/conductive, magnetic, and/or photo properties so that the color can be changed, substantially reduced, or both changed and substantially reduced when an appropriate field is applied. As an alternative to the melt synthesis of colloid-within-particle particle scattering colorants, such colorants can be synthesized by a method used by K. J. Burham et al., which is described in Nanostructure Materials 5, pp. 155-169 (1995). These authors incorporated colloidal particles in silica by doping metal salts in the silanes used for the sol-gel synthesis of the silicate. By such means they obtained Ag, Cu, Pt, Os, Co₃ C, Fe₃ P, Ni₂ P, or Ge colloidal particles dispersed in the silica. For the purposes of the present invention, colloidal particles dispersed in silica can be ground into suitable particle sizes for use as particle scattering colorants.

Instead of an inorganic glass, the particle containing the colloid particles can be a polymer. It is known in the art to prepare films of colloidal dispersions of various metals in the presence of vinyl polymers with polar groups, such as poly(vinyl alcohol), polyvinylpyrrolidone, and poly(methyl vinyl ether). Particle scattering colorants suitable for the use in the present embodiment can be obtained by cutting or grinding (preferably at low temperatures) a polymer film formed by solvent evaporation of the colloidal dispersion. More preferably, such particle scattering colorants can be formed by eliminating the solvent from an aerosol comprising colloidal particles dispersed in a polymer-containing solvent. Particle scattering colorants that are either semiconductors or metallic conductors are among preferred compositions for use in polymer fibers. Such particle scattering colorants will generally provide significant absorption at visible wavelengths. In such case it is preferred that the particle scattering colorant has an average diameter in the smallest dimension of less than about 2 microns, the neat polymer matrix is substantially non-absorbing in the visible, and the minimum in transmitted visible light intensity for the particle scattering colorant is shifted by at least by about 10 nm as a result of the finite particle size of the particle scattering colorant. More preferably, this shift is at least about 20 nm for the chosen particle sizes of the particle scattering colorant and the chosen matrix material. For assessing the effect of particle size on the minimum of transmitted light intensity, a particle size above about 20 microns provides a good approximation to the infinite particle size limit.

For particle scattering colorant compositions that provide a single maximum in absorption coefficient within the visible range when particle sizes are large, another application of the standard transmitted light intensity ratio enables the identification of preferred particle scattering colorants. This method is to identify those particle scattering colorants that have at least two minima in transmitted light intensity ratio that occur within the visible wavelength range. Such two minima, possibly in addition to other minima, can result from either a bimodal distribution of particle sizes, or differences in the minimum resulting from absorptive processes and scattering processes for a mononodal distribution of particle sizes. If the particle scattering colorants are required for applications in which switchability in coloration states are required, it is preferable that these two minima arise for a mononodal distribution in particle sizes. The reason for this preference is that the switchability in the refractive index difference between matrix and particle scattering colorant can provide switchable coloration if particle scattering effects are dominant. Thus, in another embodiment of this technology, this switchable coloration due to changes in the refractive index is combined with changes or loss in coloration due to agglomeration of particles. Mononodal and bimodal particle distributions, referred to above, designate weight-fraction particle distributions that have one or two peaks, respectively.

For applications in which reversible color changes in response to temperature changes are desired, particular ceramics that undergo reversible electronic phase changes are preferred particle scattering colorants. Such compositions that undergo reversible transitions to highly conducting states upon increasing temperature are VO₂, V₂ O₃, NiS, NbO₂, FeSi₂, Fe₃O₄, NbO₂, Ti₂O₃, Ti₄O₇, Ti₅O₉, and V₁₋ₓM_{xO}₂, where M is a dopant that decreases the transition temperature from that of VO₂ (such as W, Mo, Ta, or Nb) and where x is much smaller than unity. VO₂ is an especially preferred color-changing particle additive, since it undergoes dramatic changes in both the real and imaginary components of refractive index at a particularly convenient temperature (about 68° C.). The synthesis and electronic properties of these inorganic phases are described by Speck et al. in Thin Solid Films 165, 317-322 (1988) and by Jorgenson and Lee in Solar Energy Materials 14, 205-214 (1986).

Because of stability and broad-band ability to absorb light, various forms of aromatic carbon are preferred electronic transition colorants for use in enhancing the coloration effects of particle scattering colorants. Such preferred compositions include various carbon blacks, such as channel blacks, furnace blacks, bone black, and lamp black. Depending upon the coloration effects desired from the combined effects of the particle scattering colorant and the electronic colorant, various other inorganic and organic colorants that are conventionally used by the pigment and dye industry are also useful. Some examples of such inorganic pigments are iron oxides, chromium oxides, lead chromates, ferric ammonium ferrocyanide, chrome green, ultramarine blue, and cadmium pigments. Some examples of suitable organic pigments are azo pigments, phthalocyanine blue and green pigments, quinacridone pigments, dioxazine pigments, isoindolinone pigments, and vat pigments.

The use of either electronic transition colorants that are dichroic or a dichroic matrix composition can be used to provide novel appearances. Such novel appearances can result, for example, since the scattering of particle scattering colorants can display a degree of polarization. Preferential orientation of the dichroic axis is preferred, preferably either parallel or perpendicular to the fiber axis for a fiber or in the film plane for a film, and can be conveniently achieved by conventionally employed methods used to make polarizers, such as mechanical drawing. The dichroic behavior can be usefully developed either in the same matrix component in which the particle scattering colorant is dispersed or in a different matrix component. One preferred method for providing dichroic polymer matrix materials for the large Δn embodiments is by incorporating a dye molecule in the polymer, followed by uniaxially stretching the matrix containing the dye molecule. Such a dye molecule serves as a dichroic electronic absorption colorant. The effect of the mechanical stretching process is to preferentially orientate the optical transition axis of the dye molecule with respect to the stretch axis of the polymer. The creation of polarizing films by the mechanical stretching of a polymer host matrix is described by Y. Direx et al. in Macromolecules 28, pp. 486-491 (1995). In the example provided by these authors, the dye was sudan red and the host matrix was polyethylene. However, various other combinations of dye molecules and polymer matrices are suitable for achieving the polarizing effect that can be usefully employed in the particle scattering colorant composites of the present embodiments.

Various chemical compositions that are capable of providing switchability in refractive index or adsorption coefficients are useful for either host matrices, particle scattering colorants, or electronic transition colorants that enhance the effects of scattering particle colorants. In order to achieve novel coloration effects that are anisotropic, all of these switchable chemical compositions that are anisotropic can optionally be incorporated in a preferentially orientated manner in fabricated articles. By providing refractive index and electronic transition changes that occur as a function of thermal exposure, light exposure, or humidity changes, such materials (either with or without preferential orientation) provide a switchable coloration state. Various color-changing chemicals suitable for use in the present invention are known, such as the anils, fulgides, spiropyrans, and other photochromic organics as described in the text entitled “Organic Photochromes”, A. V. El'tsov (Consultants Bureau, New York, 1990). Such color changing chemicals can be employed as electronic transition colorants that modify the visual effect of particle scattering colorants in polymer composites. Also, color changes in response to temperature, light exposure, or humidity can alternatively be produced by using the many well-known materials that provide refractive index changes in response to these influences, and no significant change in absorption coefficients at visible light wavelengths. Such materials can be used as either the matrix material or the particle scattering colorants for the color changing composites.

Photopolymerizable monomers, photo-dopable polymers, photo-degradable polymers, and photo cross-linkable polymers are also available for providing the switchable refractive indices and switchable electronic absorption characteristics that enable the construction of articles having switchable particle scattering coloration. Materials suitable for this use are described, for example, by J. E. Lai in “Polymers for Electronic Applications”, Chapter 1, pages 1-32, edited by J. E. Lai (CRC Press, Boca Raton, Fla., 1989). Improved materials are described by G. M. Wallraff et al. in CHEMTECH, pp. 22-30, April 1993, and more exotic compositions are described by M. S. A. Abdou et al. in Chem. Mater. 3, pages 1003-1006 (1991). Examples of photopolymerizable monomers and oligomers are those containing two of more conjugated diacetylene groups (that are polymerizable in the solid state), vinyl ether terminated esters, vinyl ether terminated urethanes, vinyl ether terminated ethers, vinyl ether terminated functionalized siloxanes, various diolefins, various epoxies, various acrylates, and hybrid systems involving mixtures of the above. Various photoinitiators are also useful for such systems, such as triarylsulfonium salts.

Polymer colored articles can also contain fillers, processing aids, antistats, antioxidants, antiozonants, stabilizers, lubricants, mold release agents, antifoggers, plasticizers, and other additives standard in the art. Unless such additives additionally serve desired purposes as particle scattering colorants or electronic transition colorants, such additives should preferably either dissolve uniformly in the polymer that contains the particle scattering colorant or such additives should have a degree of transparency and a refractive index similar to the matrix polymer. Dispersing agents such as surfactants are especially useful for dispersing the particle scattering colorant particles. Many suitable dispersing agents and other polymer additives are well known in the art and are described in volumes such as “Additives for Plastics”, edition 1, editors J. Thuen and N. Mehlberg (D.A.T.A., Inc., 1987). Coupling agents that improve the coupling between particle scattering particles and host matrix are especially important additives for vanishing Δn embodiments, since they can eliminate fissure formation or poor wetting at particle-matrix interfaces. For cases where either a glass or a ceramic is the particle scattering colorant, and the host matrix is an organic polymer, preferred coupling agents are various silanes that are commercially available and designed to improve bonding in composites that involve both inorganic and organic phases. Examples of suitable coupling agents for particle scattering colorant composites of this type are 7169-45B and X1-6124 from Dow Corning Company.

Various methods can be employed for the compounding and fabrication of composites. For example, particle scattering colorants can be compounded with polymeric matrix materials via (1) melt-phase dispersion, (2) solution-phase dispersion, (3) dispersion in a colloidal polymer suspension, or (4) dispersion in either a prepolymer or monomer for the polymer. Films of the composite can be either formed by solvent evaporation or by adding a non-solvent to a solution containing dispersed ceramic powder and dissolved polymer followed by sample filtration, drying, and hot pressing. In method (4), the ceramic particles can be dispersed in a monomer or prepolymer that is later thermally polymerized or polymerized using actinic radiation, such as ultraviolet, electron-beam, or gamma-ray radiation. Particle scattering colorants can also be combined with the matrix by xerographic, powder coating, plasma deposition, and like methods that are well known in the art. For example, particle scattering colorants can be added to fabrics or carpet by using xerography techniques described in “Printing Textile Fabrics with Xerography” (W. W. Carr, F. L. Cook, W. R. Lanigan, M. E. Sikorski, and W. C. Tinche, Textile Chemist and Colorist, Vol. 23, no. 5, 1991). The coating of textile, carpet fiber, and wallpaper articles with particle scattering colorants in a fusible polymer matrix, so as to obtain coloration, is an especially important embodiment because of the commercial importance of speedy delivery of articles that accommodate frequent style and color changes and individual customer preferences. Such deposition can optionally be preceded by a separate deposition of an electronic transition colorant in order to enhance the effect of the particle scattering colorant.

In order to obtain uniform mixing of the ceramic in the host polymer, ultrasonic mixers can be used in the case of low viscosity composite precursor states and static mixers and more conventional mixers can be used for melt blending processes. Static mixers, which are particularly useful for melt blending processes, are available commercially from Kenics Corporation of Danvers, Mass., and are described by Chen and MacDonald in Chemical Engineering, Mar. 19, 1973, pp. 105-110. Melt-phase compounding and melt-phase fabrication are preferred for the compositions useful in the present invention. Examples of useful melt-phase fabrication methods are hot rolling, extrusion, flat pressing, and injection molding. For the fabrication of the more complicated shapes, injection molding and extrusion are especially preferred.

In some cases it is desirable to achieve a degree of controlled aggregation of the particle scattering colorants in order to achieve anisotropy in coloration effects. Such aggregation to produce anisotropy in coloration is preferably in either one dimension or two dimensions, wherein the direction of such aggregation for different particle aggregates are correlated. Such correlation in aggregation is most conveniently achieved by plastic mechanical deformation of a matrix that is heavily loaded with the particle scattering colorant. For example, such mechanical deformation can be in the fiber direction for a fiber or in either one or both of two orthogonal directions in the film plane for a film. As an alternative to using particle aggregation to achieve anisotropy in coloration, anisotropy in particle shape can be used to achieve the similar effects. For example, mechanical deformation of films and fibers during processing will generally cause plate-like particles to preferentially orient with the plate plane orthogonal to the film plane and fiber-like particles to preferentially orient with the particle fiber axis parallel to the fiber axis of the composite.

A special type of particle scattering colorant orientation effect is especially useful for vanishing Δn embodiments. In such embodiments it is usually preferred that the particle scattering colorants and matrix materials are isotropic in optical properties. However, in order to obtain novel angle-dependent coloration effects, one can preferentially orient plate-like particles of an anisotropic particle scattering colorant in polymer films so that an optic axis of the particles is normal to the film plane. Such particles and polymer matrix are chosen so that the ordinary refractive index (nₒ) of the particles equals that of the matrix at a wavelength in the visible. Hence, a film article will appear highly colored when light perpendicular to the film plane is transmitted through the film. However, light that is similarly viewed that is inclined to the film plane will be scattered at all wavelengths so the article will appear either uncolored or less intensely colored. In such embodiments the particle scattering colorant is chosen to be one that has the optic axis perpendicular to the particle plate plane, which is the case for many materials having either hexagonal, trigonal, or tetragonal symmetry. Preferential orientation of the plane of the plate-like particles parallel to the film plane can be obtained by various conventional processes, such as film rolling processes, film formation by solution deposition processes, and biaxial stretching processes. Note that such plate-like particle scattering colorants are quite different from the plate interference colorants of the prior art. For these prior art colorants, no match of refractive indices of matrix and particle is required, and, in fact, large refractive index differences between the particles and the matrix throughout the visible can increase the coloration effect.

Fibers useful in the present invention can either be formed by conventional spinning techniques or by melt fabrication of a film followed by cutting the film into either continuous fibers or staple. An electronic transition colorant can be optionally included in the composite film composition. Alternately, a polymer film containing the particle scattering colorant can be adhesively joined either to one side or to both sides of a polymer film that contains an electronic transition colorant. The adhesive tie layer between these polymer film layers can be any of those typically used for film lamination. However, it is preferable to employ the same matrix polymer for the joined films and to select the tie layer to have about the same refractive index as this matrix polymer. Alternately, the central film layer containing electronic transition colorant and the outer film layers containing the particle scattering colorant can be coextruded in a single step using well-known technologies of polymer film coextrusion. If the desired end product is a polymer fiber, these multilayer film assemblies can be subsequently cut into fiber form. Microslitter and winder equipment is available from Ito Seisakusho Co., Ltd (Japan) that is suitable for converting such film materials to continuous fibers. Particularly interesting visual effects can be obtained if these fibers are cut from a bilayer film that consists of a polymer film layer containing the particle scattering colorant on one side and a polymer film layer containing an electronic transition colorant on the opposite side. Such fibers that provide a different visual appearance for different viewing angles can be twisted in various applications, such as carpets and textiles, to generate a spatially colored material due to the appearance in one viewing angle of alternating segments with different coloration. One coloration effect is provided if the fiber side that is in closest view is the particle scattering colorant film layer and another coloration effect is provided if the side that is in closest view is the electronic transition colorant film layer. Such special coloration effects of cut film fibers are most visually noticeable if the cut film fiber strips have a width-to-thickness ratio of at least 5. Additionally, dimensional compatibility of such fiber for commingling with conventional polymer fibers in textile and carpet applications is increased if the cut film fibers have a denier that is less than 200. As an alternative to the slit-film process, either bilayer or multilayer fibers having these characteristics can be directly melt spun using a spinneret that is designed using available technology of spinnerets.

Sheath-core fibers suitable for use in the invention are fibers comprising a sheath of a first composition and a core of a second composition. Either the sheath or the core can be organic, inorganic, or mixed inorganic and organic, independent of the composition of the other component. Preferably both the sheath and core of such fibers contain organic polymer compositions. Also, the particle scattering colorant is preferably located in the sheath and an electronic transition colorant is preferably located in the core. By choice of either sheath or core cross-sectional geometry that does not have circular cylindrical symmetry, it is possible to provide fibers that provide different colorations when viewed in different lateral directions. For example, the external sheath geometry can be a circular cylinder and the core can be an ellipse having a high aspect ratio. When viewed orthogonal to the fiber direction along the long axial direction of the ellipse, the effect of the electronic transition colorant can dominate coloration. On the other hand, a corresponding view along the short axis of the ellipse can provide a visual effect that is less influenced by the electronic transition colorant. More generally, in order to achieve such angle dependent visual effects the maximum ratio of orthogonal axial dimensions in cross-section for the outer surface of the sheath is preferably less than one-half of the corresponding ratio for the core. Alternatively, the sheath and core should preferably both have a maximum ratio of orthogonal axial dimensions in cross-section that exceeds two and the long-axis directions in cross-section of sheath and core should preferably be unaligned. Such fibers that provide a different visual appearance for different viewing angles can be twisted in various applications, such as carpets and textiles, to generate a spatially colored material whose appearance in one viewing angle is determined by alternating segments with different coloration.

The ability to change the coloration of sheath-core fibers by varying the relative cross-sections of sheath and core provides for the convenient fabrication of yarns that display interesting visual effects because of variations in the coloration of different fibers in the yarn. Such variation can be accomplished, for example, by varying the relative or absolute sizes of the sheath and cores, their relative shapes, and the relative orientation of the sheath and core cross-sections. For any of these cases, the said variation can be provided either along the length of individual fibers or for different fibers in a yarn. Preferably in these embodiments, the particle scattering colorant is in the fiber sheath and an electronic transition colorant is in the fiber core. Also, a yarn consisting of such fibers is preferably assembled directly after spinning from a multi-hole spinneret. Variation in the individual spinneret hole constructions, or variation in the feed pressures for the sheaths and cores for different fiber spinning holes, can permit the desired fiber-to-fiber variations in either sheath cross-section, the core cross-section, or both. Alternatively, variation in the coloration of individual fibers along their length can be achieved by convenient means. These means can, for example, be by varying as a function of spinning time either (1) either the sheath polymer feed pressure or the core polymer feed pressure or (2) the relative temperatures of the sheath and the core polymers at the spinneret. Of these methods, variation in coloration along the lengths of individual fibers is preferred, and such variations are preferably achieved by changing the relative feed pressures of the sheath and core fiber components. Such pressure variations are preferably accomplished simultaneously for the spinneret holes that are used to produce different fibers and such spinneret holes for different fibers are preferably substantially identical. Yarns are preferably formed from the fibers at close to the point of spinning, so that correlation in the location of like colors for different fibers is not lost. As a result of such preferred embodiment, the color variations of individual fibers are spatially correlated between fibers, so these color variations are most apparent in the yarn.

The fact that fiber coloration depends upon both the sheath/core ratio and mechanical draw processes when the particle scattering colorant is in the sheath and the electronic transition colorant is in the core provides important sensor applications. These sensor applications utilize the coloration changes resulting from fiber wear and other fiber damage processes, such as the crushing of fibers which can provide coloration by deforming the cross-sections of sheath and core, abrasion or fiber dissolution which can change the cross-section of the fiber sheath, and fiber stretching (which can change the cross-sections of sheath and core, provide particle scattering colorant aggregation, and increase both polymer chain orientation and fiber crystallinity). In any case, the basis for these color changes is generally a changing relative contribution from particle scattering colorant and electronic transition colorant to article coloration. Such sensors can provide valuable indication of damage in articles such as ropes, slings, and tire cord where the possibility of catastrophic failure and uncertainties in when such failure might occur lead to frequent article replacement. These sheath/core fibers can be used either as a color-indicating minority or majority fiber in such articles.

Further methods can be used to obtain particle-induced coloration for fibers that are spun in hollow form. The particles that provide coloration via scattering can be dispersed in a suitable liquid, which subsequently fills the hollow fibers. Optional electronic transition colorants can be included in this liquid in order to enhance the coloration effect. This approach is enabled by using either a precursor fiber that is staple (i.e., short open-ended cut lengths) or to use hollow fibers that contain occasional micro holes, where the hollow fiber core breaks to the surface. The existence of these micro holes enables rapid filling of the fibers. Modest pressures of preferably less than 2000 psi can be used to facilitate rapid filling of the fibers. A low viscosity carrier fluid is preferably chosen as one that can be either photopolymerized or thermally polymerized after the filling process. As an alternative to this approach, the particle scattering colorant can be included in molten polymer from which the hollow fibers are melt spun. Then the polymerizable fluid that is drawn into the hollow fiber after spinning can include an electronic transition colorant for enhancing the coloration effect of the particle scattering colorant. Various modifications of these methods can be employed. For example, melt spun fibers can contain various combinations of particle scattering and electronic transition colorants, as can the fluid that is drawn into the hollow fibers. As another variation of these methods, hollow fibers spun from a melt that contain a particle scattering colorant can be coated on the interior walls with a material that absorbs part of the light that is not scattered by the particle scattering colorant. For example, such coating can be accomplished by drawing an oxidant-containing monomer solution for a conducting polymer, solution polymerizing the conducting polymer onto the interior walls of the hollow fibers, and then withdrawing the solution used for polymerization from the hollow fibers. The inner walls of hollow fibers are preferably colored with an electronic transition colorant using a solution dye process that requires thermal setting. For example, a dye solution can be imbibed into the hollow fibers by applying suitable pressure, any dye solution on the exterior surface of the fibers can be washed away, the dye coloration can be set by thermal treatment, and the dye solution contained within the fibers can be removed (such as by evaporation of an aqueous solution). As an alternative to thermal setting, the setting of the dye on the inner surface of the hollow fibers can be by either photochemical or heating effects of radiation, such as electron beam, ultraviolet, or infrared radiation. Such thermal or photoassisted setting of the dye can be accomplished in a patterned manner, thereby providing fibers that display the type of spatial coloration effects that are sought after for carpet and textile applications.

The same methods above described for obtaining internal wall dyeing of hollow fibers can be used for the achievement of novel optical effects via deposition of particle scattering colorants on the inside of hollow fibers. These particle colorants are preferably deposited by imbibing a colloidal solution containing the particle scattering colorant into the hollow fibers and then evaporating the fluid that is the carrier for the colloidal particles. The liquid in which the colloidal particles are dispersed can optionally contain a material that forms a solid matrix for the colloidal particles after fluid components are eliminated. Such colloidal particle scattering colorants, whether deposited on the inner walls as a neat layer or as a dispersion in a matrix, can then be optionally coated with an electronic transition colorant by methods described above for coating the inner walls of hollow fibers that are not coated with particle scattering colorants. Note that the above described deposition of colloidal particles on the inside of hollow fibers can result in aggregation of these particles to the extent that they transform from particle scattering colorants to electronic transition colorants. Depending on the coloration effect desired, aggregation can be either desirable or undesirable. Aggregation can be enhanced by selecting particles which respond to electric/conductive, magnetic, and/or photo properties so that the color can be changed, substantially reduced, or both changed and substantially reduced when an appropriate field is applied.

In the following embodiments, particle scattering colorants are used in hollow fibers to produce photochromism. Such photochromism can be achieved using particle scattering colorants that are photoferroelectrics. Preferred photoferroelectrics for this application are, for example, BaTiO₃, SbNbO₄, KNbO₃, LiNbO₃, and such compositions with optional dopants such as iron. These and related compositions are described in Chapter 6 (pp. 85-114) of “Photoferroelectrics” by V. M. Fridkin (Springer-Verlag, Berlin, 1979). Photovoltages of the order 10³ to 10⁵ volts can be generated for photoferroelectrics, although it should be recognized that these photovoltages decrease as the particle size in the polarization direction decreases. The corresponding photo-generated electric fields can be used to reversibly produce aggregation (i.e., particle chaining) of photoferroelectric particles that are dispersed in a low conductivity liquid within the cavity of a hollow fiber. If these photoferroelectric particles have suitably small dimensions, aggregation and deaggregation processes will provide a photo-induced change in the visual appearance and coloration of the fiber. The electrical conductivity of the fluid can determine the rate of return of the coloration to the initial state after light exposure ceases, since this conductivity can lead to the compensation of the photo-induced charge separation that provides the photo-induced field. Methods described above can be used for the filling of the hollow fibers with the photoferroelectric-containing liquid, and such liquid can be sealed in the fibers by a variety of processes, such as by periodic closure of the hollow tubes using mechanical deformation. Articles consisting of these photochromic fibers can be used for various applications, such as clothing that automatically changes color upon light exposure.

In another embodiment, the particle scattering colorant is a photoferroelectric that is dispersed in a solid matrix that has the same refractive index as the photoferroelectric at some wavelength in the visible (either when the photoferroelectric is not exposed to light or after it has been exposed to light, or both). This embodiment uses the large refractive index changes that occur upon the exposure of a photoferroelectric to light, which shifts the wavelength at which refractive index matching occurs (or either causes or eliminates such refractive index matching), thereby causing a coloration change in response to light.

In previously discussed embodiments (for sheath-core fibers, trilayer and bilayers films and derived cut-film fibers, and hollow polymer fibers), the use of particle scattering colorants in a layer that is exterior to the layer containing an electronic transition colorant has been described. One described benefit is the novel coloration effects achieved. Another benefit of such configurations is particularly noteworthy. Specifically, particle scattering colorants that provide blue coloration also generally provide significant scattering in the ultraviolet region of the spectra that can cause the fading of many electronic transition colorants. Hence, this ultraviolet scattering can protect the underlying electronic transition colorants from fading due to ultraviolet light exposure.

Preferred embodiments result from the advantages of using a particle scattering colorant to provide ultraviolet light protection for ultraviolet-light sensitive fiber and film products. For articles in which the particle scattering colorant is dispersed in a first matrix material that is substantially exterior to a second matrix component comprising an electronic transition colorant (such as for above described hollow fibers, sheath-core fibers, and trilayer films and derived cut-film fibers) it is preferred that (1) the first matrix component and materials contained therein absorb less than about 90% of the total visible light that can be incident on the article from at least one possible viewing angle, (2) the absorption coefficient of the first matrix component and materials contained therein is less than about 50% of that of the second matrix component and materials contained therein at a wavelength in the visible, (3) and the particle scattering colorant is substantially non-absorbing in the visible. In addition, it is preferable that the first matrix component and materials contained therein either absorb or scatter more than about 50% of uniform radiation at the ultraviolet wavelength at which the second matrix component comprising the electronic dopant undergoes the maximum rate of color fading. The term uniform radiation means radiation that has the same intensity for all spherical angles about the sample. Uniform radiation conditions exist if there is the same radiation intensity for all possible viewing angles of the article. The average particle size that is most effective for decreasing the transmission of light through a matrix at a wavelength λₒ is generally greater than about λₒ/10 and less than about λₒ/2. Hence, for maximum protection of an electronic transition colorant that most rapidly fades at λₒ, the average particle for the particle scattering colorant should preferably be from about λₒ/2 to about λₒ/10. Additionally, for this purpose the particle scattering colorant should preferably be approximately spherical (having an average ratio of maximum dimension to minimum dimension for individual particles of less than four) and there should be little dispersion in the sizes of different particles. Most preferably the average particle size for the particle scattering colorants used for ultraviolet light protection of electronic transition pigments should be from about 0.03 to about 0.1 microns. Particle scattering colorants that are especially preferred for conferring ultraviolet light protection for electronic transition colorants are titanium dioxide and zinc oxide.

Materials suitable for the present art include inorganic or organic materials that have any combination of organic, inorganic, or mixed organic and inorganic coatings. The only fundamental limitation on such a coating material is that it provides a degree of transparency in the visible spectral region if the entire surface of the article is covered with such a coating material. Preferred coating materials for application to film, fiber, or molded part surfaces are well-known materials that are called antireflection coating materials, since they minimize the reflectivity at exterior surfaces. Such antireflection coatings can enhance the visual effect of particle scatting colorants by decreasing the amount of polychromatically reflected light. Antireflection coatings can be provided by applying a coating to the surface of an article so that the refractive index of the coating is close to the square root of the refractive index of the surface of the article and the thickness of the coating is close to λₒ/4, where λ is the approximate wavelength of light that is most problematic. For example, antireflection coatings can be obtained by well known means for polymers such as polycarbonate, polystyrene, and poly(methyl methacrylate) by fluorination of the surface, plasma deposition of fluorocarbon polymers on the surface, coating of the surface with a fluoropolymer from solution, or in situ polymerization of a fluoromonomer that has been impregnated on the surface. Even when the refractive index of the antireflection polymer layer does not closely equal the square root of the refractive index of the surface of the article, light is incident at an oblique angle to the surface, and the wavelength of the light substantially deviates from λ, antireflection properties suitable for the present application can be obtained using such single layers. Furthermore, the known technologies of broadband, multilayer antireflection coatings can be used to provide antireflection coatings having improved performance. Hence, antireflection coatings can be provided for essentially any substrate, such as a polymer film, that decrease the polychromatic surface reflection that can interfere with the visual effect of particle scattering colorants.

The ability to arrange the light scattering particles in a patterned manner is important for achieving the spatial coloration that is desirable for many articles, such as polymer fibers. A number of processes can be used to achieve such spatial coloration. One method is to use the effect of magnetic fields on ordering magnetic colloidal fluids, such fluids being transformable into solid materials by thermal or photochemical setting. Such thermal setting is preferably either by decreasing temperature to below a glass transition or melting temperature or by thermal polymerization. Such photochemical setting is preferably by photo-polymerization to a glassy state. Another useful setting process is solvent evaporation from the colloidal suspension. Such setting should be substantially accomplished while the magnetic material is in a magnetic-field-ordered state, so that novel optical properties are conferred on the article by scattering and absorptive effects of the ordered magnetic material. Examples of magnetic colloidal suspensions that can be used to provide novel coloration effects are either water-based or organic-based suspensions of nanoscale magnetic oxides. Such suspensions, called ferrofluids, are obtainable commercially from Ferrofluidics Corporation, Nashua N.H. and are described by K. Raj and R. Moskowitz in the Journal of Magnetism and Magnetic Materials, Vol. 85, pp. 233-245 (1990). One example of how magnetic particles can be deposited in a spatially variant way is indicated by returning to the above examples of hollow fibers. Such hollow fibers can be filled with a dispersion of the magnetic particles in a polymerizable fluid. The magnetic particles can be spatially distributed in a desired pattern along the length of the hollow fibers using a magnetic field. Finally, the fluid can be polymerized or cross-linked thermally or by exposure to actinic radiation in order to set the structure. Polyurethane thermosets provide one preferred type of thermally set fluid for this application.

Spatially variant coloration of fibers and films can be accomplished quite simply by mechanical drawing processes that vary along the length of the fiber or film. Variation in the degree of draw can provide variation in the refractive index of the polymer matrix and the degree of stretch-induced crystallinity. These variations provide spatially dependent variation in the coloration resulting from particle scattering colorants. For such spatially dependent variation of coloration to be visually perceived, predominant color changes should occur less frequently than every 200 microns, unless the separation between regions having different optical properties is sufficiently short to provide diffraction grating or holographic-like effects.

Especially interesting and attractive visual effects can be achieved by the deposition of particle scattering colorants as a pattern that is spatially variant on the scale of the wavelength of light. The result of such patterning is the creation of a holographic-like effect. The preferred particle scattering colorants useful in the present embodiment have refractive indices for all wavelengths in the visible spectra-which do not equal those of the host matrix at the same wavelength, which is in contrast with the case of Christiansen filters. In fact, it is preferable that the particle scattering colorants that are patterned to provide the holographic effect differ from that of the matrix by at least about 10% throughout the visible region. Most preferably, this difference in refractive index of particle scattering colorant and host matrix is at least about 20% throughout the visible region of the spectra.

The particle scattering colorant embodiments useful in the present invention that are described above do not necessarily require the arrangement of the individual particles as an array having translational periodicity. Such arrangement is sometimes desirable, since novel visual appearances can result, especially intense iridescent coloration. The problem is that it has been so far impossible to achieve such periodic arrangements in either the desired two or three dimensions on a time scale that is consistent with polymer processing requirements, which are dictated by economics. The presently described embodiment provides an economically attractive method to achieve these novel visual effects for polymers. The particle scattering colorants of this embodiment consist of primary particles that are arranged in a translationally periodic fashion in m dimensions, where m is either 2 or 3. At least one translational periodicity of the particle scattering colorants is preferably similar to the wavelength of light in the visible spectrum. More specifically, this preferred translational periodicity is from about 50 to about 2000 nm. More preferably this translational periodicity is from about 100 to about 1000 nm. In order to obtain such translational periodicity, it is desirable for the particle scattering colorant to consist of primary particles that have substantially uniform sizes in at least m dimensions. The particle scattering colorant can optionally comprise other primary particles, with the constraint that these other primary particles are either small compared with the above said primary particles or such other primary particles also have relatively uniform sizes in at least the said m dimensions. The average size of the primary particles in their smallest dimension is preferably less than about 500 nm.

The first step in the process is the preparation of translationally ordered aggregates of the primary particles. Since this first step does not necessarily occur on the manufacturing lines for polymer articles, such as fibers, films, or molded parts, the productivity of such manufacturing lines need not be reduced by the time required for the formation of particle scattering colorants consisting of translationally periodic primary particles. The second step in the process is to commingle the particle scattering colorant with either the polymer host matrix or a precursor thereof Then, as a third step or steps, any needed polymerization or crosslinking reactions can be accomplished and articles can be fashioned from the matrix polymer containing the particle scattering colorant particles. In order to optimize desired visual effects, it is critically important that such second and third step processes do not completely disrupt the translationally periodic arrangement of primary particles within the particle scattering colorants. This can be insured in a number of ways. First, the average size of the particle scattering colorant particles in the smallest dimension should preferably be less than about one-third of the smallest dimension of the polymer article. Otherwise mechanical stresses during article manufacture can disrupt the periodicity of the primary particles in the particle scattering colorant. The particle scattering colorant dimension referred to here is that for the particle scattering colorant in the shaped polymer matrix of the polymer article. However, it is also preferable that the particle sizes of the particle scattering colorant in the fashioned polymer matrix of the polymer article are those initially formed during the aggregation of the arrays of primary particles. The point is again that mechanical steps, such as mechanical grinding, should be avoided to the extent possible if these steps potentially disrupt the translation periodicity within the particle scattering colorant, such as by the production of cracks or grain boundaries within the particle scattering colorant.

Various methods can be used for the first step of forming the particle scattering colorant particles containing translationally periodic primary particles. One useful method is described by A. P. Philipse in Journal of Materials Science Letters 8, pp. 1371-1373 (1989). This article describes the preparation of particles having an opal-like appearance (having intense red and green scattering colors) by the aggregation of silicon spheres having a substantially uniform dimension of about 135 nm. This article also teaches that the mechanical robustness of such particle scattering colorant having a three dimensionally periodic arrangement of silica spheres can be increased by high temperature (a few hours at 600° C.) treatment of the silica sphere assembly. Such treatment decreased the optical effectiveness of the particle scattering colorant, since the particles became opaque. However, Philipse taught that the particle aggregates recover their original iridescent appearance when immersed in silicon oil for a few days. Such treatment (preferably accelerated using either applied pressure, increased temperature, or a reduced viscosity fluid) can also be used to produce the particle scattering colorant useful in the present invention. However, it is more preferable if the mechanical robustness is achieved by either (1) forming the translationally periodic assembly of spherical primary particles from a fluid that can be latter polymerized, (2) either imbibing or evaporating a fluid to inside the as-formed translationally periodic particle assembly and then polymerizing this fluid, or (3) annealing the translationally periodic particle assembly (as done by Philipse), either imbibing or evaporating a fluid in inside this particle assembly, and then polymerizing this fluid. Alternatively, materials can be dispersed inside the periodic array of primary particles by gas phase physical or chemical deposition, such as polymerization from a gas phase. Such methods and related methods that will be obvious to those skilled in the art can be employed to make the particle scattering colorants that are useful in the present embodiment. For example, the primary particles can be either organic, inorganic, or mixed organic and inorganic. Likewise, the optional material that is dispersed within the array of primary particles in the particle scattering colorants can be organic, inorganic, or mixed organic and inorganic. In cases where the particle scattering colorants would be too opaque to optimize visual coloration effects if only gas filled the void space between primary particles, it is useful to use either a liquid or solid material in such spaces. Such liquid or solid material can minimize undesired scattering effects due to fissures and grain boundaries that interrupt the periodic packing of the primary particles. In such case, it is preferable if such fluid or solid has a refractive index in the visible range that is within 5% of the primary particles.

Another method for providing useful particle scattering colorants utilizes polymer primary particles that form an ordered array in polymer host, which serves as a binder. Films suitable for the preparation of such particle scattering colorants were made by E. A. Kamenetzky et al. as part of work that is described in Science 263, pp. 207-210 (1994). These authors formed films of three-dimensionally ordered arrays of colloidal polystyrene spheres by the ultraviolet-induced setting of a acrylamid-methylene-bisacrylamide gel that contained an ordered array of such spheres. The size of the polymer spheres was about 0.1 microns, and the nearest neighbor separation of the spheres was comparable to the wavelength of visible light radiation. A method for producing films consisting of three-dimensionally ordered polymer primary particles that do not utilize a binder polymer is described by G. H. Ma and T. Fukutomi in Macromolecules 25, 1870-1875 (1992). These authors obtained such iridescent films by casting an aqueous solution of monodispersed poly(4-vinylpyridine) microgel particles that are either 250 or 700 nm in diameter, and then evaporating the water at 60° C. These films were mechanically stabilized by a cross-linking reaction that used either a dihalobutane or p-(chloromethyl)styrene. Particle scattering colorants suitable for use in the present embodiments can be made by cutting either of the above described film types so as to provide particles of desired dimensions. One preferred cutting method is the process used by Meadowbrook Inventions in New Jersey to make glitter particles from metallized films. Various mechanical grinding processes might be used for the same purpose, although it should be recognized that low temperatures might be usefully employed to provide brittleness that enables such a grinding process. For use as particle scattering colorants, it is preferable that the cutting or grinding process produce particles that are of convenient dimension for incorporation without substantial damage in the host matrix, which is preferably a polymer.

The particle scattering colorants of this embodiment are preferably formed in required sizes during the aggregation of primary particles. Any methods used for post-formation reduction in particle sizes should be sufficiently mild as to not interfere with the desired periodicity of the primary particles. Likewise, processing conditions during commingling of the particle scattering colorant in either the polymer matrix (or a precursor therefore) and other steps leading to the formation of the final article should not substantially destroy the optical effect of the periodic assembly of primary particles. For particle scattering colorants that are not designed to be mechanically robust, preferred processes for mixing of particle scattering colorant and the matrix polymer (or a precursor thereof) are in a low viscosity fluid state, such as in a monomer, a prepolymer, or a solution of the polymer used for the matrix. For such polymers that are not designed to be mechanically robust, film fabrication and article coating using solution deposition methods are preferred for obtaining the particle scattering colorant dispersed in the shaped matrix polymer. Likewise, for such non-robust particle scattering colorants, polymer matrix formation in shaped form by reaction of a liquid containing the particle scattering colorant is preferred, such as by thermal polymerization, photopolymerization, or polymerization using other actinic radiations. Reaction injection molding is especially preferred for obtaining molded parts that incorporate particle scattering colorants that are not mechanically robust.

In another embodiment, the particle scattering colorant consists of primary particles that are translationally periodic in two dimensions, rather than in three dimensions. Fiber-like primary particles having an approximately uniform cross-section orthogonal to the fiber-axis direction tend to aggregate in this way when dispersed in suitable liquids. Likewise, spherical primary particles tend to aggregate as arrays having two-dimensional periodicity when deposited on planar surfaces. For example, such particles can be formed on the surface of a liquid (or a rotating drum) in a polymer binder that adhesively binds the spherical particles into two-dimensional arrays. These array sheets can then be either cut or ground into the particle sizes that are desired for the particle scattering colorant.

For each of the above embodiments of particle scattering colorants that consist of translationally periodic primary particles, it is preferable for the volume occupied by the particle scattering colorants to be less than about 75% or the total volume of the matrix polymer and the particle scattering colorant. The reason for this preference is that the use of low loading levels of the particle scattering colorant can lead to improved mechanical properties for the composite, relative to those obtained at high loading levels. As described above for particle scattering colorants that are not aggregates of periodically arranged primary particles, the visual effect of the particle scattering colorants consisting of ordered arrays of primary particles can be enhanced using electronic transition colorants. Such means of enhancement, as well as methods for achieving color change effects that are switchable, are analogous to those described herein for other types of particle scattering colorants.

From a viewpoint of achieving coloration effects for polymer articles that are easily eliminated during polymer recycling, particle scattering colorants that consist of translationally-ordered primary particle arrays can provide special advantages, especially if the primary particles do not substantially absorb in the visible region and the polymer article does not include an electronic transition colorant. The reason is that processing steps that disrupt such arrays can greatly reduce coloration effects. From this viewpoint of polymer recycling, it is useful to provide particle scattering colorants that are conveniently disrupted by either thermal, mechanical, or chemical steps.

Security articles of the present invention can be based on film, slit film, sheets and fibers. Fibers can be formed into security threads by conventional fiber processes such as twisting, cabling, braiding, texturizing and heat setting. The same or different security fibers may be incorporated in a security thread. The security article can be the film, slit film, sheet, fiber or security thread as well as objects in which at least one fiber or thread is dispersed or on which film, slit film, at least one fiber or thread, etc. is incorporated, e.g., by lamination. In a construction in which the film, slit film, fiber, thread etc., is incorporated within or on the article, the average length of the material to be incorporated can be substantially equal to the length or width dimension of the object on or in which it is incorporated. For example, its average size can be about equal to the object; alternatively, it can be from about 25 to about 100 percent of the object's size; or from about 35 to about 95 percent; or from about 50 to about 90 percent. Manufacturing and use considerations will typically determine such features. For articles on or in which fibrils and/or dots are included, the average dimensions of the latter materials are typically substantially smaller than that of the articles, including the typical thickness of such an article. Useful security articles and objects include identification documents such as passports and laminated identification cards, currency and banknotes, negotiable instruments, stocks and bonds, licenses including drivers' licenses, diplomas, credit and debit cards, security identification cards, automatic teller machine (ATM) or banking access cards, and other important documents in which are dispersed or applied security threads, dots, fibrils and/or slit plastic film incorporating the security features of the present invention. Furthermore, plastic film incorporating the security features can be used directly to produce the types of security articles described as well as others. In addition, threads can be used to produce luminescent logos that also incorporate security features in fabrics or clothing. The security articles of the invention can also be used to produce bar codes for use in various identification and security applications. For example, each bar of a bar code can comprise a fiber, thread or fibril incorporating the same or different security technology described herein, thereby allowing for customization of such codes and introduction of a further level of security. A cabled security thread can be tailored to specific end uses through combinations of colors, luminescent response and particle scattering technology.

It is also within the scope of the present invention to incorporate mixtures of security contributing components, e.g., chopped filament or fibers, fibrils, dots, filaments and fibers, in which there is present one luminescent type of substance in one and another luminescent substance in another; or in which there is a combination of one particle scattering coloration substance and one luminescent substance in one and a luminescent substance in another, provided that the security article comprises at least one luminescent substance and at least one particle scattering colorant. In this manner, it is possible to achieve security effects that can significantly frustrate counterfeiting efforts of the security article. For example, fibrils can be added to a plastic or cellulosic matrix wherein the fibrils exhibit mixed coloration effects, e.g., a proportion of fibrils exhibiting particle scattering coloration in combination with fluorescence and others exhibiting phosphorescence alone; or dots exhibiting fluorescence in combination with filaments exhibiting particle scattering coloration in combination with phosphorescence; or dots and fibrils each exhibiting particle scattering coloration and fluorescence; etc. The ability to combine and observe the coloration effects by use of the distinct technologies described herein can provide a level of security for various article and applications not previously available.

Accordingly, security articles of the present invention comprises a polymer, cellulosic or glass matrix component and, in various permutations and combinations, colorants based on the luminescent technology and particle scattering technology described hereinabove. The polymer matrix component can also comprise a mixture or blend of homopolymers or copolymers and other additives typically present in a polymer composition can be used to facilitate processability of the composition, improve oxidative, ozone or color stability, or achieve one or more physical or performance characteristics advantageous in the particular application. In particular, a security article comprises at least one particle scattering colorant and at least one luminescent substance. Dispersion of dots and/or fibrils in a papermaking composition, including paper suitable for printing secure documents such as diplomas, licenses and banknotes or currency, can be used to produce paper incorporating security features that would thwart counterfeiting. Similarly, incorporation of the security articles of the present invention in the blanks used to manufacture credit cards, debit cards, automatic teller machine access cards, etc. can similarly protect against the attempted use of counterfeit or falsified cards. Such papers and cards can be used for print, including words and images.

In the accompanying examples formic acid viscosity (FAV) of nylon 6 is determined using the procedure described in ASTM-D789-97, with the following differences: a Cannon-Fenske viscometer, otherwise called a modified Ostwald viscometer, is utilized in lieu of the calibrated pipet-type viscometer specified; and 5.50 g per 50.0 mL of 90% formic acid is utilized in lieu of the specified quantity of 11.00 g per 100 mL of 90% formic acid.

All references herein to elements or metals belonging to a certain Group refer to the Periodic Table of the Elements as it appears in Hawley's Condensed Chemical Dictionary, 13^{th} Edition. Also, any references to the Group or Groups shall be to the Group or Groups as reflected in this Periodic Table of Elements using the “New Notation” system for numbering groups.

The following examples are given as specific illustrations of the invention. It should be understood, however, that the invention is not limited to the specific details set forth in the examples. All parts and percentages in the examples, as well as in the remainder of the specification, are by weight unless otherwise specified.

Further, any range of numbers recited in the specification or paragraphs hereinafter describing or claiming various aspects of the invention, such as that representing a particular set of properties, units of measure, conditions, physical states or percentages, is intended to literally incorporate expressly herein by reference or otherwise, any number falling within such range, including any subset of numbers or ranges subsumed within any range so recited. The term “about” when used as a modifier for, or in conjunction with, a variable, is intended to convey that the numbers and ranges disclosed herein are flexible and that practice of the present invention by those skilled in the art using temperatures, concentrations, amounts, contents, carbon numbers, and properties that are outside of the range or different from a single value, will achieve the desired result, namely, compositions and colored articles prepared therefrom responsive to various regions of the electromagnetic spectrum and methods for preparing same.

### EXAMPLES

Each of the compositions shown in the following table use Honeywell International Inc. nylon 6 (grade MBM, 55 FAV). Except for the control, each of the mixtures is tumble blended for about 2 hours in a twin shell dry mixer with. The components comprising the control and mixtures are dried separately in a vacuum oven at 120° C. overnight. The LUMILUX® pigment, LUMILUX® Red CD 740 is manufactured by Honeywell Specialty Chemicals. The phosphorescent afterglow pigment, designated NYA is a 30 wt. % masterbatch concentrate of a green Luminova® pigment in Nylon 6 (Nemoto Co., Ltd., Tokyo, Japan).

| | | Chemical | |
|---|---|---|---|
| Sample | Component | Composition/Type | Wt. % |
| 1 | MBM Nylon 6 | Nylon 6 | 100 |
| (Control) | | | |
| 2 | Lumilux Red CD 740 | Inorganic luminescent | 5 |
| | MBM Nylon 6 | pigment | 95 |
| | | Nylon 6 | |
| 3 | AgNO₃ masterbatch | 0.1 wt. % AgNO₃ in | 10 |
| | Phosphorescent | Nylon MBM | 3 |
| | afterglow* | Metal aluminate oxide | 5 |
| | Lumilux Red CD 740 | Inorganic luminescent | 82 |
| | MBM Nylon 6 | pigment | |
| | | Nylon 6 | |
| 4 | AuCl₃ masterbatch | 0.1 wt. % AuCl₃ in | 10 |
| | Phosphorescent | Nylon MBM | 3 |
| | afterglow* | Metal aluminate oxide | 5 |
| | Lumilux Red CD 740 | Inorganic luminescent | 82 |
| | MBM Nylon 6 | pigment | |
| | | Nylon 6 | |

The blended mixture is fed to a Leistritz brand twin screw extruder of 18 mm diameter and 40:1 L/D. The extruder screws have mixing and kneading elements as well as conveying elements. The extruder barrel zone temperatures are set at 250-255° C. The polymer melt is delivered to a Zenith brand gear pump and then passed through a graded screen pack consisting of 17 screens ranging from 20 mesh down to 325 mesh (44 micrometer opening). After passing through the screen pack, the polymer melt issues from a 14 hole spinneret having a capillary diameter of 0.024 inches and a depth of 0.072 inches to produce a round filament cross-section. The issuing melt filaments are solidified by co-current quench air flow at about 19.5° C. The extrusion rate is 44.6 g/min and the initial fiber take-up speed is 579 meters/min. The fiber is drawn 3.3:1 in-line with spinning. Final fiber dimensional and tensile properties (measured by ASTM D2256)

| Sample | 1 | 2 | 3 | 4 |
|---|---|---|---|---|
| Denier/filament: | 216 | 159 | 157 | 162 |
| Tenacity, g/d | 4.77 | 4.27 | 4.22 | 4.27 |
| Initial Modulus, | 25.75 | 28.22 | 26.36 | 31.31 |
| g/d | | | | |
| Ultimate | 52.28 | 32.44 | 29.96 | 32.28 |
| Elongation, % | | | | |

The filaments of this example have the complex cross-section shown in FIG. 1 (complexity factor of 7), one component, and when illuminated by a mercury UV lamp, has multiple fluorescent responses with peaks at 622 nanometers (red) and at 880 and 1060 nanometers in the infra-red. Under normal illumination the AgNO₃-containing filaments are beige colored and those containing AuCl₃ are silver colored. Thin transverse sections of the filaments are cut for use as dots, and chopped filaments are prepared. To prepare security articles, the filaments, dots and chopped filaments are dispersed in a cellulosic matrix, film and plastic cards. The articles display color and luminescent characteristics under appropriate illumination.

The principles, preferred embodiments, and modes of operation of the present invention have been described in the foregoing specification. The invention which is intended to be protected herein, however, is not to be construed as limited to the particular forms disclosed, since these are to be regarded as illustrative rather than restrictive. Variations and changes may be made by those skilled in the art, without departing from the spirit of the invention.

1. A security article comprising a matrix component in which:
(A) at least one particle scattering colorant is dispersed; and
(B) at least one luminescent substance is dispersed;
wherein:
(1) said at least one particle scattering colorant comprises particles selected from the group consisting of a semiconductor, metallic conductor, metal oxide, metal salt or mixture thereof;
(2) said at least one particle scattering colorant has an average cross-sectional size in the smallest dimension of less than about 0.2 micron;
(3) said polymer matrix component is substantially non-absorbing in the visible region of the spectrum;
(4) said particle scattering colorant has a minimum in the transmitted light intensity ratio in the 380 to 750 nanometer range that is shifted at least by 10 nanometers compared with that obtained for the same semiconductor, metallic conductor, metal oxide, metal salt or mixture thereof having an average particle size above about 20 microns; and
(5) said luminescent substance is selected from the group consisting of at least one fluorescent substance, at least one phosphorescent substance, mixtures of at least one fluorescent and at least one phosphorescent substance, wherein said luminescent substance exhibits a luminescent spectral response peak when excited by at least one wavelength selected from the electromagnetic spectral region of from about 200 to about 2,000 nanometers.

2. A security article comprising at least one first composition and at least one second composition:
(A) said first composition comprising a solid first matrix component, a particle scattering colorant and at least one luminescent substance dispersed therein;
(B) said at least one second composition comprising a polymer second matrix component, and a colorant selected from the group consisting of an electronic transition colorant, dye and pigment dispersed therein;
(C) said at least one first composition being either;
(1) disposed on and substantially exterior to said second composition on at least one side of the article; or
(2) said first and second compositions are substantially mutually interpenetrating;
wherein:
(i) there exists at least one incident visible light wavelength and one incident light angle such that said first composition absorbs less than about 90% of the light incident on said article;
(ii) the absorption coefficient of said at least one first composition is less than about 50% of that of said second composition at a wavelength in the visible region of the spectrum;
(iii) the highest absorption peak of said particle scattering colorant does not fall in the visible region of the spectrum;
(iv) said luminescent substance is selected from the group consisting of at least one fluorescent substance, at least one phosphorescent substance, and a mixture of at least one fluorescent and at least one phosphorescent substance, wherein said luminescent substance exhibits a luminescent spectral response peak when excited by one or more wavelength selected from the electromagnetic spectral region of about 200 to about 2,000 nanometers; and
(v) either:
(a) said particle scattering colorant has a refractive index that matches that of said first matrix component at a wavelength in the visible and has an average particle size of less than about 2000 microns; or
(b) the average refractive index of said particle scattering colorant differs from that of said first matrix component by at least about 5% in the visible wavelength range, the average particle size of said particle scattering colorant in the smallest dimension is less than about 2 microns, and said particle scattering colorant, when dispersed in a colorless, isotropic liquid having a substantially different refractive index, is characterized at visible wavelengths as having an effective maximum absorbance that is at least about 2 times the effective minimum absorbance.

3. The article of claim 1 wherein said particle scattering colorant particles comprise a metallic conductor selected from the group consisting of gold, platinum, copper, aluminum, lead, palladium, silver, rhodium, osmium, iridium, and alloys thereof and said particle scattering colorant particles have an average diameter in the smallest dimension of less than about 0.2 microns.

4. The article of claim 3 wherein the particle scattering colorant particles comprise one or more colloidal particles.

5. The article of claim 4 wherein the transmitted light intensity ratio has two minima in the wavelength region of the visible spectra and the particle distribution of the particle scattering colorant approaches a mononodal distribution.

6. The article of claim 2 wherein said at least one first composition either absorbs or scatters more than about 50% of uniform radiation at the ultraviolet wavelength at which said at least one second composition undergoes the maximum rate of color fading.

7. The article of claim 2 wherein said particle scattering colorant is substantially non-absorbing in the visible region.

8. The article of claim 2 wherein the refractive index of said particle scattering colorant is substantially different than that of said first matrix component at all wavelengths in the visible region of the spectrum and wherein at least about 50% of all particles of said particle scattering colorant have a smallest dimension that is less than about 0.25 microns.

9. The article of claim 2, wherein for said particle scattering colorant:
(a) the average particle size is from about 0.001 to about 0.4 microns;
(b) the average ratio of maximum dimension to minimum dimension for individual particles is less than about four; and
(c) the refractive index is substantially different than that of the matrix at all wavelengths in the visible region of the spectrum.

10. The article of claim 2 wherein:
(a) the average particle size for the particle scattering colorant is less than about 1000 microns;
(b) both the first matrix component and the particle scattering colorants are substantially optically isotropic;
(c) there exists a wavelength in the visible region of the spectrum at which the refractive index of said first matrix component substantially equals that of said particle scattering colorant;
(d) the refractive index difference of said first matrix component and said particle scattering colorant is substantially dependent on wavelength in the visible range;
(e) and said first matrix composition is substantially non-absorbing at wavelengths in the visible region of the spectrum.

11. The article of claim 10 wherein the difference in n_{F}−n_{C} for the particle scattering colorant and for the first matrix component is greater in absolute magnitude than 0.001, wherein n_{F} and n_{C} are the refractive indices at 486.1 nm and 656.3 nm respectively of the particle scattering colorant and the first matrix component.

12. The article according to claims 1 or 2 wherein said matrix component is selected from the group consisting of polymers, cellulosic compositions and glasses and wherein said luminescent substance comprises at least one fluorescent substance and at least one phosphorescent substance.

13. The article of claim 12 wherein said phosphorescent substance has afterglow characteristics.

14. The article according to claims 1 or 2 wherein at least one of said first and second matrix components comprises at least one material selected from the group consisting of homopolymers and copolymers of polyamide, polyester, polyolefin, polyvinyl, acrylic, polysulfone, polycarbonate, polyarylate and polystyrene.

15. The article of claim 2 wherein said first matrix component and said second matrix component are substantially mutually interpenetrating and where αₑvₑVₑ for said second composition and αₛvₛVₛ for said first composition differ by less than a factor of ten at a wavelength in the visible region; wherein αₑ is the absorption coefficient for the electronic transition colorant; αₛ is the effective absorption coefficient for the particle scattering colorant; vₛ and vₑ are, respectively, the volumes of said at least one first and second compositions; and V_{S} and Vₑ are respectively the volume fraction of said at least one first composition that is the particle scattering colorant and the volume fraction of said at least one second composition that is the electronic transition colorant.

16. The article of claim 2 wherein said at least one first composition is disposed on and is substantially exterior to said second matrix composition on at least one side of said article; said at least one second composition comprises an electronic transition colorant or a pigment; there exists a wavelength of visible light and a light incidence angle at which from about 10% to about 90% light transmission occurs through said at least one first composition; and αₑtₑVₑ is greater than 0.1 for said at least one second composition; wherein αₑ is the absorption coefficient at the wavelength in the visible region at which the maximum absorption occurs for said electronic transition colorant or the pigment; tₑ is a maximum thickness of the layer comprising said at least one second composition; and Vₑ is the volume fraction of said at least one second composition comprising said electronic transition colorant or pigment.

17. An article selected from the group consisting of a filament and a fiber and comprising a composition selected from the compositions recited in any of claims 1 and 2.

18. The article of claim 17 wherein said at least one first composition forms a sheath that substantially covers a core of said filament or of said fiber comprising said second matrix component.

19. The article of claim 18 wherein said sheath and said core have differing cross-sectional shapes.

20. The article of claim 19 in which the maximum ratio of orthogonal axial dimensions in cross-section for an outer surface of said sheath is less than about one-half of the corresponding ratio for said core.

21. The article of claim 18 where said sheath and said core both have a maximum ratio of orthogonal axial dimensions in cross-section that exceeds two and the long axis directions in cross-section of said sheath and said core are unaligned.

22. An element comprising a plurality of articles according to claim 18, wherein said element has either spatially dependent coloration for individual articles or coloration for individual articles resulting from variations in the cross-section of said sheath or the cross-section of said core.

23. The article of claim 2 in which said particle scattering colorant in said at least one first composition comprises an inorganic composition.

24. The article of claim 23 wherein said inorganic composition comprises at least one material selected from the group consisting of bismuth oxychloride, titanium dioxide, antimony trioxide, barium titanate, solid solutions of BaTiO₃ with SrTiO₃, PbTiO₃, BaSnO₃, CaTiO₃, or BaZrO₃, potassium lithium niobate, aluminum hydroxide, zirconium oxide, colloidal silica, lithium niobate, lithium tantalite, proustite; zinc oxide, alpha-zinc sulfide, and beta-zinc sulfide.

25. The article according to claims 1 or 2 wherein said particle scattering colorant comprises a ferroelectric, antiferroelectric, or photoferroelectric material.

26. The article of claim 25 in which said ferroelectric material is a relaxor ferroelectric ceramic.

27. The article of claim 26 wherein said relaxor ferroelectric ceramic has a Curie transition temperature of from about 250° K. to about 350° K.

28. The article of claim 26 wherein said relaxor ferroelectric ceramic has the form A(BF_{1/2}BG_{1/2})O₃ where BF and BG represent the atom types on the B sites in a lead titanate type of structure, or is an alloy of one or more compositions of such form with another ceramic composition, and wherein A is Pb and BF_{1/2} and BG_{1/2} are independently Sc_{1/2}, Ta_{1/2}, Fe_{1/2}, or Nb_{1/2}.

29. The article of claim 26 wherein said relaxor ferroelectric ceramic has the form A(BF_{1/3}BG_{2/3})O₃, where BF and BG represent the atom types on the B sites in a lead titanate type of structure, or is an alloy of one or more compositions of such form with another ceramic composition, and wherein A is Pb, BF_{1/3} is Mg_{1/3}, Ni_{1/3} or Zn_{1/3}, and BG_{2/3} is Nb_{2/3}.

30. An article of claim 29 wherein said relaxor ferroelectric ceramic comprises Pb(Mg_{1/3} Nb_{2/3})O₃.

31. The article of claim 30 which includes up to 35 mole percent of alloyed PbTiO₃.

32. The article according to claims 1 or 2 which is in the form of a film or planar structure in which a layer of said at least one first composition is joined to either one side or to both opposite sides of said at least one second composition comprising said film or planar structure.

33. An article selected from the group consisting of a visual display and a switchable image comprising the article of claim 32, wherein said article further comprises a colorant selected from the group consisting of a particle scattering colorant, an electronic transition colorant, and a matrix switchable in either refractive index or absorption coefficient.

34. The article of claim 33 wherein an applied electric field changes a property selected from the group consisting of refractive index and absorption coefficient of said colorant.

35. The article of claim 33 wherein said article comprises a ferroelectric, antiferroelectric, or photoferroelectric composition.

36. The article of claim 2 wherein the refractive index difference between said first polymer matrix component and either said particle scattering colorant or said electronic transition colorant undergoes substantial change at a wavelength in the visible spectra as a result of one or more of a temperature change, humidity change, an electric field, integrated thermal exposure, or exposure to either light or actinic radiation.

37. The article of claim 36 which undergoes a detectable color change responsive to one or more of chemical agents, pressure, temperature, moisture pickup, temperature limit, or time-temperature exposure.

38. The article of claim 36 wherein said electronic transition colorant comprises a photochromic anil, fulgide, or spiropyran.

39. The article of claim 2 comprising either an electronic transition colorant or a matrix polymer that displays electronic transition coloration, wherein dichroism in the visible range results from either preferential orientation of said electronic transition colorant or said matrix polymer.

40. The article of claim 17 wherein said fiber is a hollow fiber comprising a cavity central to said fiber and having an average dimension less than the overall average dimension of said fiber, said hollow fiber comprising a particle scattering colorant wherein:
(a) said particle scattering colorant is present within said cavity; or
(b) said particle scattering colorant is dispersed in a polymer-containing matrix that forms a sheath surrounding said hollow fiber; and
(c) wherein the internal surface of said hollow fiber adjacent said cavity is colored with a material that significantly absorbs light in the visible region of the spectrum.

41. The hollow fiber of claim 40 comprising a plurality of lateral holes extending from said cavity of said fiber to the external surface of said fiber, wherein the average separation of adjacent holes along the length of said fiber is less than about 25.4 cm, and the average hole diameter is capable of imbibing a liquid into said fiber at a pressure of less than 13.8 MPa.

42. The hollow fiber of claim 40 comprising an electronic transition colorant.

43. The hollow fiber of claim 40, wherein the average particle size of said particle scattering colorant is less than about 0.1 microns and said particle scattering colorant, when dispersed in a colorless, isotropic liquid having a substantially different refractive index, is characterized at visible wavelengths as having an effective maximum absorbance that is at least about 2 times the effective minimum absorbance.

44. The hollow fiber of claim 40, wherein said particle scattering colorant is selected from the group consisting of a semiconductor and a metallic conductor; said polymer matrix component is substantially non-absorbing in the visible region of the spectrum; and said particle scattering colorant has a minimum in the transmitted light intensity ratio in the 380 to 750 nm range that is shifted at least by 10 nm compared with that obtained for the same semiconductor or metallic conductor having an average particle size above about 20 microns.

45. The article of claim 17 comprising at least one element selected from the group consisting of at least two of said fibers and at least two of said filaments.

46. The article of claim 17 wherein the effective diameter of said filament is in the range of from about 0.01 to 3 mm.

47. The article of claim 46 comprising at least two of said fibers.

48. The article according to claims 1 or 2 wherein at least one luminescent response is produced by a wavelength in the infrared region of the electromagnetic spectrum.

49. The article according to claims 1 or 2 wherein at least one luminescent response is produced by a wavelength in the visible region of the electromagnetic spectrum.

50. The article according to claims 1 or 2 wherein at least one luminescent response is produced by a wavelength in the ultraviolet region of the electromagnetic spectrum.

51. The article according to claims 1 or 2 wherein at least two excitation wavelengths selected from different members of the group consisting of the infrared, visible, and ultraviolet region of the electromagnetic spectrum produce luminescent responses.

52. The article of claim 2 in which the particle-scattering colorant comprises a gas.

53. The article of claim 52 wherein said gas is air.

54. The article according to claims 1 or 2, wherein said particle scattering colorant has an average particle size of less than 3 microns and comprises a plurality of layers, each of said layers having a different refractive index.

55. The article of claim 54 wherein said refractive index difference is greater than about 5%.

56. The article of claim 54 wherein said refractive index difference is greater than about 10%.

57. The article according to claims 1 or 2 wherein said luminescent substance comprises at least one fluorescent substance and at least one phosphorescent substance having afterglow characteristics, wherein said article is selected from the group consisting of a filament and a fiber.

58. The article of claim 57 adapted for use on or in an object, said article selected from the group consisting of film, slit film, fibers, dots and fibrils.

59. The article of claim 58 wherein said fiber, film or slit film has an average length substantially equal to the length or width dimension of the object in which it is dispersed or on which it is incorporated.

60. The article of claim 58 wherein said fibril or said dot comprises has an average maximum dimension substantially smaller than the length or width dimension of the object in which it is dispersed or on which it is incorporated.

61. The article of claim 60 wherein said fibril or said dot has a thickness substantially smaller than the thickness of the object in which it is dispersed or on which it is incorporated.

62. The article of claim 58 wherein said object comprises at least one structural element selected from the group consisting of film and sheet.

63. The article of claim 62 wherein at least one surface thereof is suitable for incorporation of information in a form selected from the group consisting of at least one image, typeface and a mixture of at least one image and typeface.

64. The article of claim 63 wherein said object is selected from the group consisting of: currency, banknotes, negotiable instruments, passports, licenses, identification documents, credit cards, debit cards and bar codes.

65. A specific embodiment of the subject invention can be described as follows:
1. A security article comprising a matrix component in which:
(A) at least one particle scattering colorant is dispersed; and
(B) at least one luminescent substance is dispersed;
wherein:
(1) said at least one particle scattering colorant comprises particles selected from the group consisting of a semiconductor, metallic conductor, metal oxide, metal salt or mixture thereof;
(2) said at least one particle scattering colorant has an average cross-sectional size in the smallest dimension of less than about 0.2 micron;
(3) said polymer matrix component is substantially non-absorbing in the visible region of the spectrum;
(4) said particle scattering colorant has a minimum in the transmitted light intensity ratio in the 380 to 750 nanometer range that is shifted at least by 10 nanometers compared with that obtained for the same semiconductor, metallic conductor, metal oxide, metal salt or mixture thereof having an average particle size above about 20 microns; and
(5) said luminescent substance is selected from the group consisting of at least one fluorescent substance, at least one phosphorescent substance, mixtures of at least one fluorescent and at least one phosphorescent substance, wherein said luminescent substance exhibits a luminescent spectral response peak when excited by at least one wavelength selected from the electromagnetic spectral region of from about 200 to about 2,000 nanometers; and
(6) said particle scattering colorant particles comprise a metallic conductor selected from the group consisting of gold, platinum, copper, aluminum, lead, palladium, silver, rhodium, osmium, iridium, and alloys and mixtures thereof;
(7) said matrix component is selected from the group consisting of polymers, cellulosic compositions and glasses;
wherein:
(a) said luminescent substance comprises at least one fluorescent substance and at least one phosphorescent substance having afterglow characteristics;
(b) said at least one fluorescent substance and said at least one phosphorescent substance having afterglow characteristics are present in said matrix at a total concentration of from about 0.5 to about 15 weight percent;
(c) said article is selected from the group consisting of filaments, fibers, film, slit film, dots and fibrils, said article adapted for use in connection with an object;
(d) said object comprising at least one structural element adapted to accept on at least one surface thereof, information in a form selected from the group consisting of at least one image, typeface and a mixture of at least one image and typeface; and
(e) said object is selected from the group consisting of: currency, banknotes, negotiable instruments, passports, licenses, identification documents, credit cards, debit cards and bar codes.
